(19) United States
(12) Patent Application Publication
(10) Pub. No.: US 2010/0074072 A1
(43) Pub. Date: Mar. 25, 2010

(54) RECORDING METHOD, INFORMATION RECORDING APPARATUS, INFORMATION RECORDING MEDIUM, REPRODUCTION METHOD AND INFORMATION REPRODUCTION APPARATUS

(76) Inventors: Hisae KATO, Osaka (JP); Hiroshi Ueda, Nara (JP); Motoshi Ito, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/563,636

(22) Filed: Sep. 21, 2009

(30) Foreign Application Priority Data
Sep. 19, 2008 (JP) 2008-240504

(51) Int. Cl. G11B 19/02; G11B 7/26

(52) U.S. Cl. 369/47.1; 369/283; G9B/19.001; G9B/7.194

(57) ABSTRACT

Provided is an information recording/reproduction apparatus including: a recording request receiving unit for receiving a recording request for recording information on an information recording medium including two or more recording layers; and a recording unit for recording the information by, limiting the number of recording layers including an area with information recorded thereon to a predetermined value N (N≧0) or less with respect to other recording layers in which the light passes therethrough until light reaches an unrecorded area of a recording layer as a recording target. According to this configuration, it is possible to guarantee the recording quality of a multilayered information recording medium.

### BACKGROUND OF THE INVENTION

1. Field of the Invention

The present invention relates to a recording method and an information recording apparatus for recording information on an information recording medium including a plurality of recording layers, an information recording medium including a plurality of recording layers, and a reproduction method and an information reproduction apparatus for reproducing information from an information recording medium including a plurality of recording layers.

2. Description of the Background Art

A Blu-ray disc (BD) is known as a high-capacity optical disc. A BD has a maximum capacity of 25 GB with a single layer, and a maximum capacity of 50 GB by employing a dual layer.

Data is recorded on optical discs such as BDs by using a laser beam. Data is recorded by irradiating a laser beam onto the recording layer and, for instance, changing the recording layer from an amorphous state to a crystal state. Since the state of the recording layer is changed as described above, the optical transmittance and reflectance (optical characteristics) will change. Specifically, the optical characteristics will differ in a recorded area and an unrecorded area.

If the optical disc is a single layer, there will be no influence caused by differences in the optical characteristics. However, in cases of an optical disc laminated with two or more recording layers in which other recording layers exist between a recording layer as a recording target and the surface of the optical disc, as shown in FIG. 25, light that passes through the areas of other recording layers will enter the recording layer as the recording target. Thus, light that enters the recording layer as the recording target will be affected by the optical characteristics of the areas of other recording layers.

When recording data, the power of the laser beam is controlled so as to achieve optimal power in the area to be recorded. The power of a laser beam has a prescribed margin (power margin) in relation to the reference power, and the recording quality is guaranteed if data is recorded at a power within the power margin.

When attempting to record data on an inner recording layer, the change in power will be small and the power margin will not decrease if the optimal characteristics of the area of the near-side recording layer are constant. Nevertheless, if an unrecorded area and a recorded area coexist on an optical path of the laser beam, since the optical characteristics will differ in the unrecorded area and the recorded area, the change in power will increase and the power margin will decrease. Since the power margin also decreases due to other factors such as focus deviation, it is desirable to prevent the decrease in the power margin as much as possible. Specifically, with a multilayered optical disc, it is desirable to maintain the optical characteristics of the area of other recording layers in which light passes therethrough to be constant.

Thus, as a method of maintaining the optical characteristics of the areas of other recording layers in which light passes therethrough to be constant, there is a method of recording the entire area of other recording layers in which light passes therethrough when the optical disc is used for the first time.

In addition, Japanese Translation of PCT Application No. 2005-529447 discloses a method of prohibiting the recording on an area of an inner recording layer until the near-side recording layer is completely recorded by registering the area of the inner recording layer in a defect list as being defective.

According to these methods, when recording information on the inner recording layer, since the area of the near-side recording layer in which light passes therethrough will be completely recorded at all times, the optical characteristics can be maintained to be constant.

As described above, although it is desirable to maintain the optical characteristics of the area of other recording layers in which light passes therethrough to be constant, with a two-layered BD, information can be recorded anywhere on the two layers. This is because there is no need to give consideration to the influence caused by differences in the optical characteristics since it is characterized in that there is only one other recording layer in which light passes therethrough, and the power margin can be ensured even if an unrecorded area and a recorded area coexist on an optical path in which the laser beam passes therethrough.

Nevertheless, if the number of recording layers is increased to three layers, four layers, five layers and so on in order to increase the capacity, the influence caused by the differences in optical characteristics will increase since the number of recording layer in which light passes therethrough will also increase.

Thus, when attempting to record the entire area of recording layers in which light passes therethrough in order to maintain the optical characteristics of the areas of other recording layers in which light passes therethrough to be constant, much time will be required, and there is a problem in that the user will not be able to use the disc during that time. This problem becomes even more significant with a greater number of recording layers.

Moreover, with a write once optical disc, since recording can only be performed once, there is a problem in that recording cannot be performed before the initial use.

Further, since the transmittance will deteriorate if the disc is completely recorded, the power of the optical beam must be increased. Nevertheless, since the deterioration of transmittance will multiply for each increase in the number of recording layers, there is a problem in that the power of the optical beam will exceed the upper limit and it may not be possible to perform the recording.

In addition, even if the power is increased, if the number of recording layers is increased, the patterns in which the unrecorded area and the recorded area coexist will also increase, and there is a problem in that the power will not fall within the power margin and it may not be possible to guarantee the recording quality.

Moreover, with the method disclosed in Japanese Translation of PCT Application No. 2005-529447, since the recording of the inner recording layer is prohibited, there is a problem in that the recording cannot be performed when a host apparatus issues a recording request for recording on the inner recording layer.

Furthermore, when registration in the defect list is cancelled, the unused area to be notified to the host apparatus will increase, and there is a problem in that this may affect the processing of the host apparatus.

### SUMMARY OF THE INVENTION

The present invention was devised in order to overcome the foregoing problems. Thus, an object of this invention is to provide a recording method, an information recording apparatus, an information recording medium, a reproduction method and an information reproduction apparatus capable of guaranteeing the recording quality in a multilayered information recording medium.

The recording method according to one aspect of the present invention comprises a recording request receiving step of receiving a recording request for recording information on an information recording medium including two or more recording layers, and a recording step of recording the information by, limiting the number of recording layers including an area with information recorded thereon to a predetermined value N (N≧0) or less with respect to other recording layers in which the light passes therethrough until light reaches an unrecorded area of a recording layer as a recording target.

According to the foregoing configuration, it is possible to receive a recording request for recording information on an information recording medium including two or more recording layers. In addition, information is recorded by, limiting the number of recording layers including van area with information recorded thereon to a predetermined value N (N≧0) or less with respect to other recording layers in which light passes therethrough until light reaches an unrecorded area of a recording layer as a recording target.

According to the present invention, since the number of recording layers including an area with information recorded thereon is limited to a predetermined value N (N≧0) or less with respect to other recording layers in which light passes therethrough until the light reaches an unrecorded area of a recording layer as a recording target, it is possible to reduce the influence that the light which reaches an unrecorded area of a recording layer as a recording target will receive from the optical characteristics of other recording layers, and guarantee the recording quality of the multilayered information recording medium.

### BRIEF DESCRIPTION OF THE DRAWINGS

FIG. 1 is a configuration diagram of the information recording/reproduction apparatus according to the first embodiment of the present invention;

FIG. 2 is a block diagram showing the functional configuration of the information recording/reproduction apparatus according to the first embodiment of the present invention;

FIG. 3 is a diagram showing the configuration of the four-layered BD-R according to the first embodiment of the present invention;

FIG. 4 is a diagram showing the configuration of an inner zone and an outer zone according to the first embodiment of the present invention;

FIG. 5 is a diagram showing the data structure of TDMA according to the first embodiment of the present invention;

FIG. 6 is a diagram showing the data structure of TDFL according to the first embodiment of the present invention;

FIG. 7 is a diagram showing the data structure of SRRI according to the first embodiment of the present invention;

FIG. 8 is a flowchart showing the method of deciding the limiting value N according to the first embodiment of the present invention;

FIG. 9 is a first flowchart showing the recording method according to the first embodiment of the present invention;

FIG. 10 is a second flowchart showing the recording method according to the first embodiment of the present invention;

FIG. 11 is a flowchart showing the processing for searching a recording layer which is innermost from the optical entrance surface of the optical disc among recording layers which have an unrecorded area according to the first embodiment of the present invention;

FIG. 12 is a diagram showing an example of the recording status of the four-layered BD-R when recording is performed with the recording method according to the first embodiment of the present invention;

FIG. 13 is a diagram showing an example of the recording status of the four-layered BD-R when recording is performed with the recording method according to the first embodiment of the present invention;

FIG. 14 is a diagram showing an example of the recording status of the four-layered BD-R when recording is performed with the recording method according to the first embodiment of the present invention;

FIG. 15 is a block diagram showing the functional configuration of the information recording/reproduction apparatus according to the second embodiment of the present invention;

FIG. 16 is a first flowchart showing the recording method according to the second embodiment of the present invention;

FIG. 17 is a second flowchart showing the recording method according to the second embodiment of the present invention;

FIG. 18 is a diagram explaining the recording of data to an area in the same radial position according to the second embodiment of the present invention;

FIG. 19 is a first flowchart showing the method of determining whether there is a recorded area in the same radial position as the recording request area according to the second embodiment of the present invention;

FIG. 20 is a second flowchart showing the method of determining whether there is a recorded area in the same radial position as the recording request area according to the second embodiment of the present invention;

FIG. 21 is a diagram explaining the lamination error of the recording layer according to the second embodiment of the present invention;

FIG. 22A and FIG. 22B are diagrams explaining a different determination method of determining whether there is a recorded area in the same radial position as the recording request area according to the second embodiment of the present invention;

FIG. 23 is a block diagram showing the functional configuration of the information recording/reproduction apparatus according to the third embodiment of the present invention;

FIG. 24 is a flowchart showing the reproduction method according to the third embodiment of the present invention; and

FIG. 25 is a diagram showing the influence of optical characteristics of areas of other recording layers in which light passes therethrough.

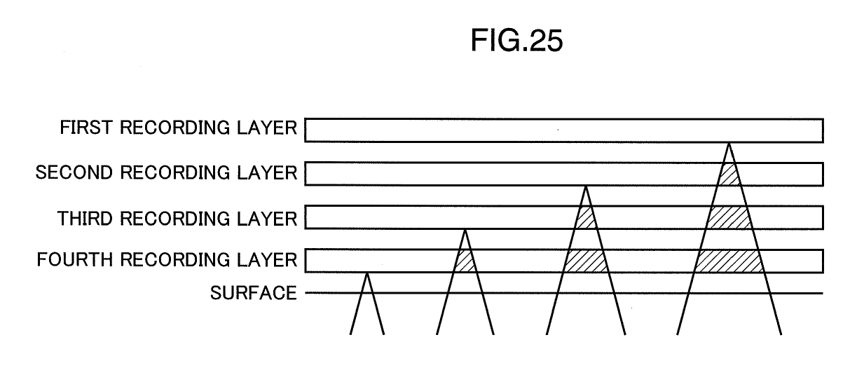

### DETAILED DESCRIPTION OF THE PREFERRED EMBODIMENTS OF THE INVENTION

Embodiments of the present invention are now explained in detail with reference to the attached drawings. Incidentally, the ensuing embodiments are merely examples that embody the present invention, and are not intended to limit the technical scope of this invention in any way.

### First Embodiment

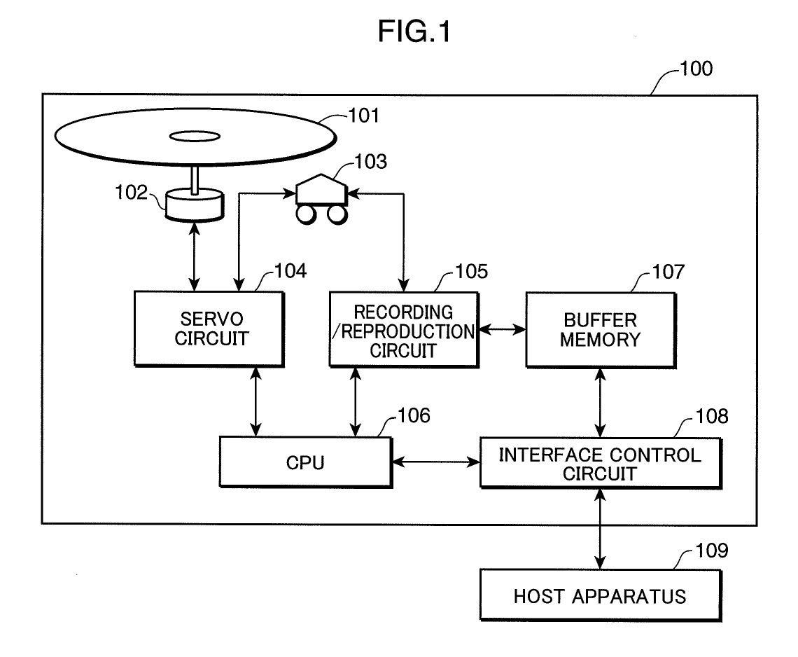

FIG. 1 is a diagram showing the overall configuration of an information recording/reproduction apparatus 100 according to the first embodiment of the present invention. The information recording/reproduction apparatus 100 depicted FIG. 1 comprises a spindle motor 102, a pickup 103, a servo circuit 104, a recording/reproduction circuit 105, a CPU 106, a buffer memory 107, and an interface control circuit 108.

In FIG. 1, an optical disc 101 as the information recording medium is rotated at a prescribed rotational speed with the spindle motor 102. The pickup 103 includes a laser beam source, a photo detector, and an optical lens system, and irradiates a laser beam on the optical disc 101 for recording and reproducing information. The servo circuit 104 controls the rotation of the spindle motor 102 and the position of the pickup 103, and controls the pickup 103 in the tracking direction and the focus direction.

The recording/reproduction circuit 105 performs reproduction processing such as binarization processing, demodulation processing, decode processing and error correction processing to the signals read by the pickup 103, and additionally performs recording processing such as encoding processing and modulation processing to the recording signals to be supplied to the pickup 103. The data to be recorded and reproduced is stored in the buffer memory 107, and is sent to and received from an externally connected host apparatus 109 (for instance, a host computer) via the interface control circuit 108. The CPU (Central Processing Unit) 106 receives commands from the host apparatus 109 via the interface control circuit 108, controls the overall operation of the information recording/reproduction apparatus 100 according to built-in control programs, and executes various types of processing such as recording processing and reproduction processing.

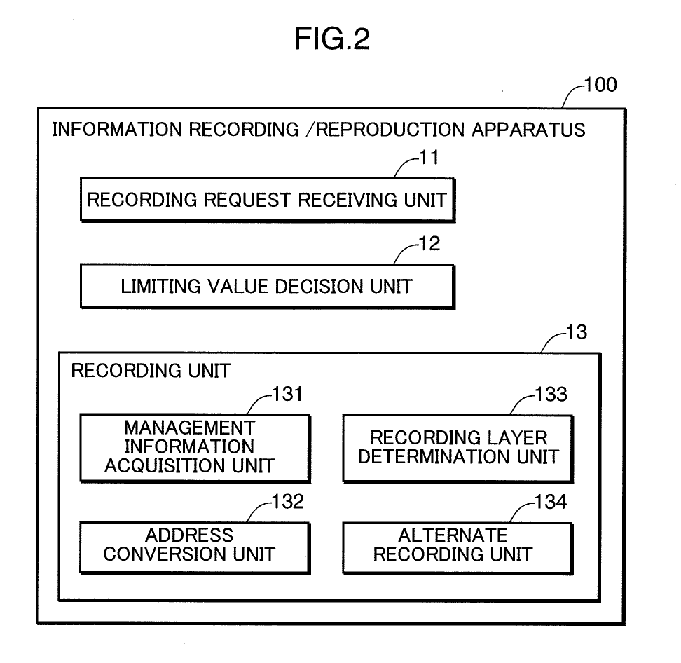

FIG. 2 is a block diagram showing the functional configuration of the information recording/reproduction apparatus 100 according to the first embodiment of the present invention. The information recording/reproduction apparatus 100 comprises a recording request receiving unit 11, a limiting value decision unit 12, and a recording unit 13. Incidentally, in the first embodiment, the information recording/reproduction apparatus 100 corresponds to an example of the information recording apparatus.

The optical disc 101 comprises two or more recording layers, and the number of recording layers including an area with information recorded thereon is limited to a limiting value N (N≧0) or less with regard to other recording layers in which light passes therethrough until light reaches an unrecorded area of a recording layer as a recording target.

The recording request receiving unit 11 receives a recording request for recording information on the optical disc 101 including two or more recording layers. Incidentally, the CPU 106 and the interface control circuit 108 depicted in FIG. 1 function as the recording request receiving unit 11.

The limiting value decision unit 12 decides the limiting value (predetermined value) N based on control data to be recorded during the manufacture of the optical disc 101. Incidentally, the CPU 106 depicted in FIG. 1 functions as the limiting value decision unit 12.

The recording unit 13 records the information by, limiting the number of recording layers having an area with information recorded thereon to a predetermined value N (N≧0) or less with respect to other recording layers in which light passes therethrough until the light reaches an unrecorded area of a recording layer as a recording target. Incidentally, the spindle motor 102, the pickup 103, the servo circuit 104, the recording/reproduction circuit 105, the CPU 106, the buffer memory 107 and the interface control circuit 108 depicted in FIG. 1 function as the recording unit 13.

The recording unit 13 comprises a management information acquisition unit 131, an address conversion unit 132, a recording layer determination unit 133 and an alternate recording unit 134. The management information acquisition unit 131 acquires the latest defect management information and the recording management information from the optical disc 101. The address conversion unit 132 converts the logical address of an area recording data and which was designated by the host apparatus 109 into a physical address.

The recording layer determination unit 133 determines whether a recording request area on a recording layer that is specified based on the recording request exists between a recording layer which is innermost from an optical entrance surface of the optical disc 101 among recording layers which have an unrecorded area and a recording layer closer to the side of the optical entrance surface for the limiting value N from the recording layer which is innermost from the optical entrance surface of the optical disc 101 among recording layers which have an unrecorded area.

If recording layer determination unit 133 determines that the recording request area does not exist between a recording layer which is innermost from an optical entrance surface of an optical disk 101 among recording layers which have an unrecorded area and a recording layer closer to the side of the optical entrance surface for the limiting value N from the recording layer which is innermost from the optical entrance surface of the optical disc 101 among recording layers which have an unrecorded area, the alternate recording unit 134 decides an unrecorded area existing between a recording layer which is innermost from an optical entrance surface of an optical disk 101 among recording layers which have an unrecorded area of the information recording medium and a recording layer closer to the side of the optical entrance surface for the limiting value N from the recording layer which is innermost from the optical entrance surface of the optical disc 101 among recording layers which have an unrecorded area as an alternate area, and records information to be recorded on the recording request area in the alternate area.

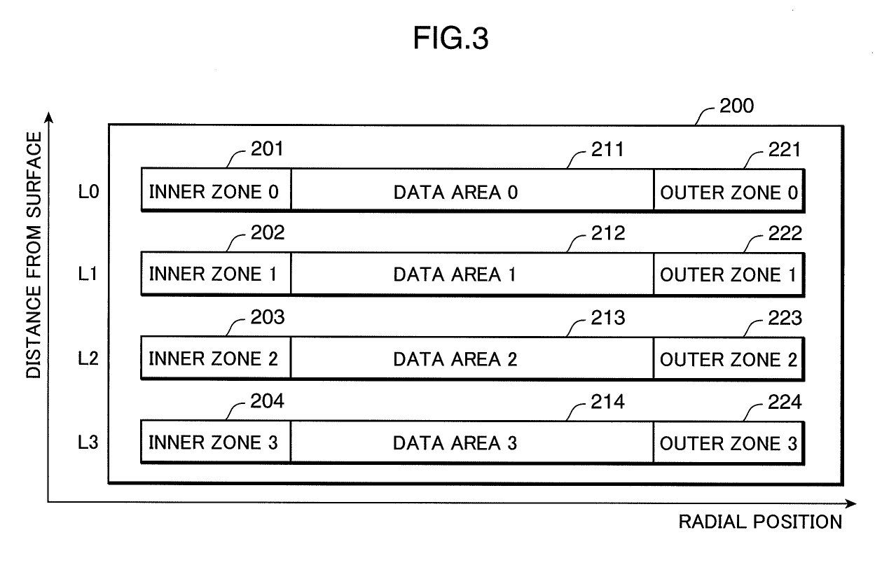

FIG. 3 is a diagram showing the configuration of the four-layered BD-R 200 according to the first embodiment of the present invention. The BD-R 200 includes, in order from the recording layer that is positioned innermost from the surface (optical entrance surface), a first recording layer L0, a second recording layer L1, a third recording layer L2 and a fourth recording layer L3. The physical addresses of the first recording layer L0 and the third recording layer L2 are allocated in ascending order from the inner peripheral side. The physical addresses of the second recording layer L1 and the fourth recording layer L3 are allocated in ascending order from the outer peripheral side. Incidentally, the layer number of each recording layer is set in the physical address of each recording layer.

Each recording layer is allocated, from the inner peripheral side, with inner zones 201 to 204, data areas 211 to 214 and outer zones 221 to 224. The data areas 211 to 214 record user data. The inner zones 201 to 204 and the outer zones 221 to 224 store defect management information, recording management information and the like.

The inner zone 201 of the first recording layer L0 stores the last physical address of each recording layer. The inner zone 201 of the first recording layer L0 stores control data. The control data is recorded during the manufacture of the disc, and includes disc information such as information representing the number of recording layers and version information representing the version (type) of optical disc.

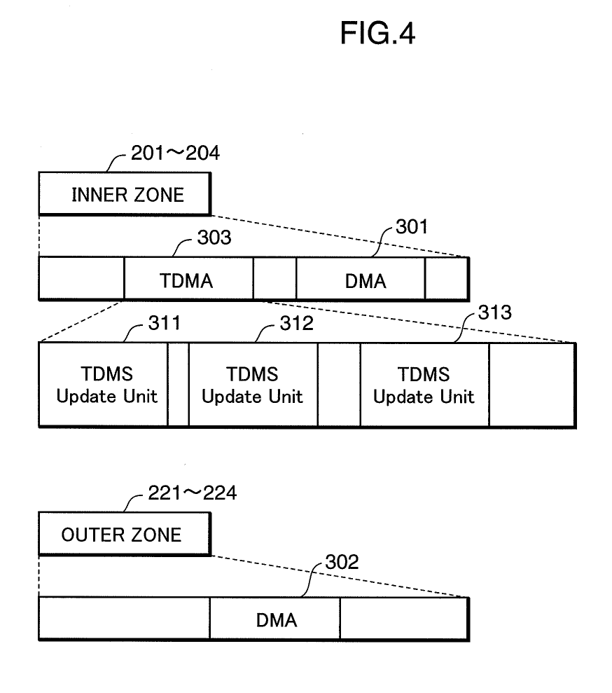

FIG. 4 is a diagram showing the configuration of an inner zone and an outer zone according to the first embodiment of the present invention. The inner zones 201 to 204 of the respective recording layers include a DMA (Disc Management Area) 301 for storing defect management information and recording management information, and a TDMA (Temporary Disc Management Area) 303 for temporarily storing defect management information and recording management information. The outer zones 221 to 224 of the respective recording layers include a DMA 302 for storing defect management information and recording management information.

The TDMA 303 is an area for temporarily storing the defect management information and recording management information until the disc is closed, and the DMAs 301, 302 are areas for storing the last management information in the TDMA 303 upon closing the disc.

The TDMA 303 records the defect management information and recording management information in units of the TDMS Update Unit, and these are recorded physically consecutively upon updating the defect management information and recording management information.

Here, although the present embodiment explains a case where one DMA is provided to each inner zone and each outer zone, and one TDMA is provided for each inner zone, the present invention is not limited thereto. For example, a plurality of DMAs and TDMAs may be provided to the respective zones or the respective recording layers. In addition, only one of either the DMA or the TDMA may exist. Moreover, it will suffice so as long as at least one DMA or one TDMA is provided to one of the recording layers.

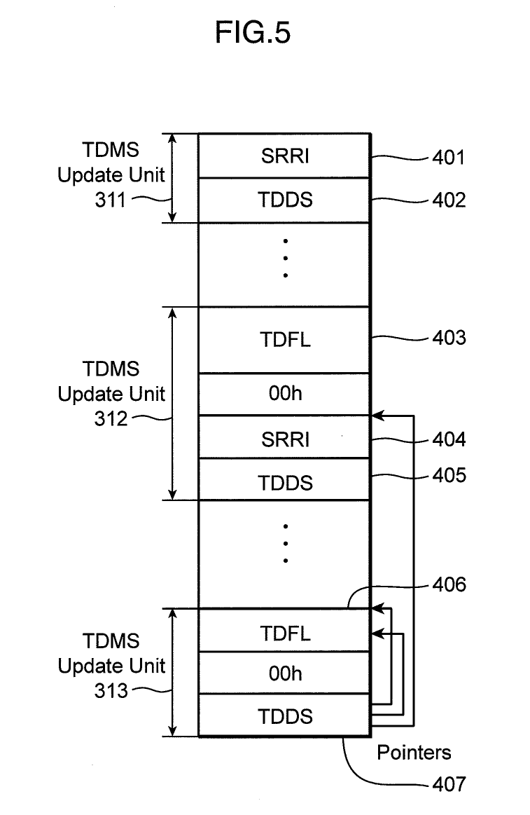

FIG. 5 is a diagram showing the data structure of TDMA 303 during the continuous recording mode according to the first embodiment of the present invention. Since the continuous recording mode is specified in the specification of the BD-R and well known, the explanation thereof will be omitted. In order to prevent the wasteful consumption of the TDMA 303, only the elements that are required for the update are recorded as the TDMS Update Unit.

In FIG. 5, the TDMS Update Unit 311 represents a case of updating only the recording management information, the TDMS Update Unit 312 represents a case of updating the defect management information and the recording management information, and the TDMS Update Unit 313 represents a case of updating only the defect management information with the latest TDMS Update Unit. The latest TDDS (Temporary Disc Definition Structure) 407 stores a pointer showing the latest defect list, and a pointer showing the latest recording management information. As a result of reproducing the latest TDDS 407, the stored pointer group can be used to refer to the latest defect list and the recording management information.

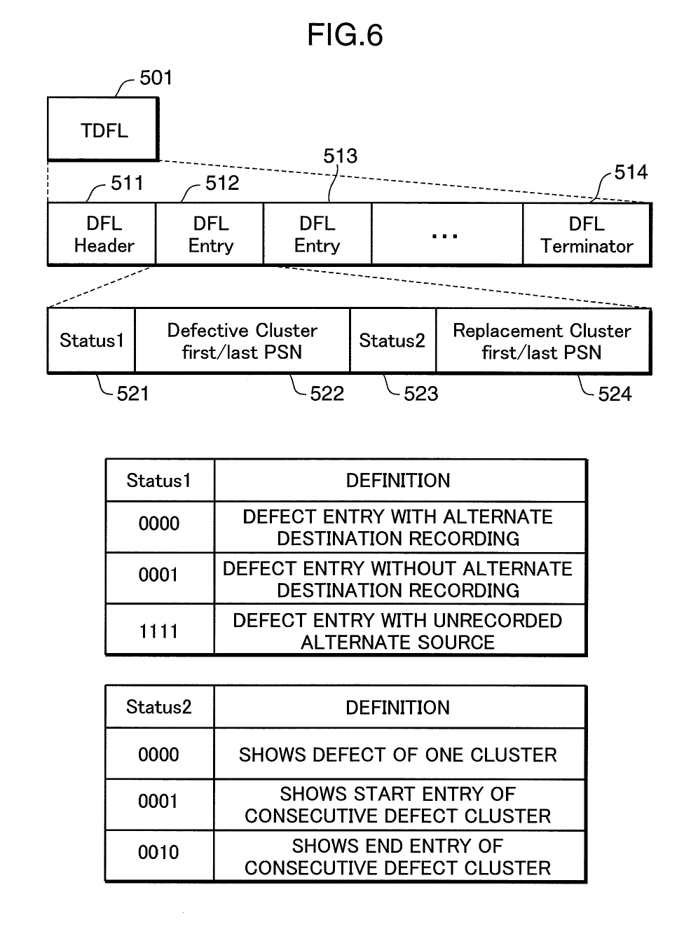

FIG. 6 is a diagram showing the data structure of a TDFL (Temporary Defect List) 501 according to the first embodiment of the present invention. The TDFL 501 is configured from a DFL Header 511 including information for identifying the defect list and configuration information of the defect list, DFL Entries 512, 513 including defect information, and a DFL Terminator 514 showing the termination of the DFL Entry. The DFL Entry includes a physical address 522 of the defect, a physical address 524 of the alternate destination, and status information 521, 523 representing the status of the physical addresses 522, 524. The status information 521 shows whether the alternate destination has been recorded, or whether the alternate source is an unrecorded area, and the status information 523 shows the consecutiveness of the defect cluster.

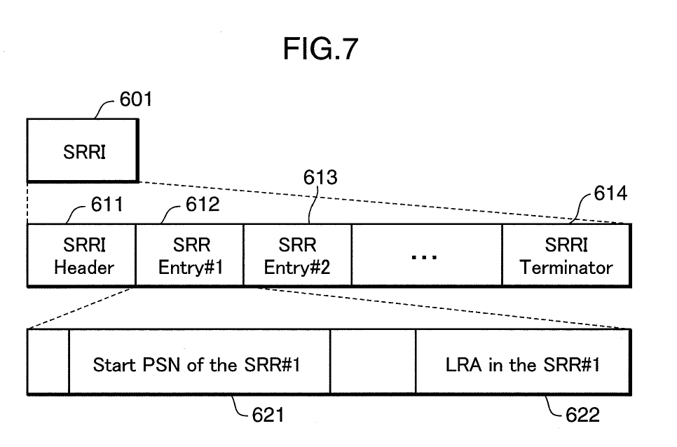

FIG. 7 is a diagram showing the data structure of an SRRI (Sequential Recording Range Information) 601 according to the first embodiment of the present invention. The SRRI 601 is configured from an SRRI Header 611 including the identifying information of the SRRI, the number of recordable Open SRRs, and a list showing the Open SRR number, SRR Entries 612, 613 including recording management information regarding the recording area, and an SRRI Terminator 614 showing the termination of the SRR Entry.

Each SRR Entry 612, 613 includes a start physical address 621 of the SRR, and a last recorded address (LRA) 622 in the SRR. The SRR number is allocated in ascending order from 1 based on the start physical address of the SRR, and the SRR Entry is also arranged in ascending order based on the SRR number.

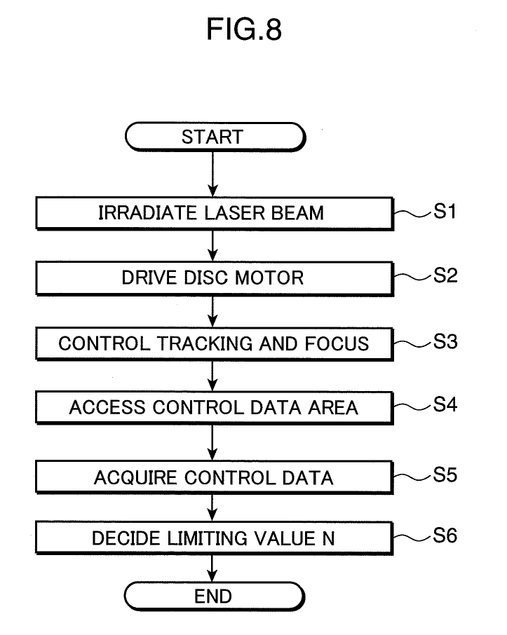

The method of recording information on the foregoing four-layered BD-R 200 using the information recording/reproduction apparatus 100 is now explained with reference to FIG. 8 to FIG. 12.

Foremost, the method of deciding the limiting value N according to the first embodiment of the present invention is explained. FIG. 8 is a flowchart showing the method of deciding the limiting value N according to the first embodiment of the present invention. When the four-layered BD-R 200 is loaded into the information recording/reproduction apparatus 100, the host apparatus 109 issues a start-up command to the information recording/reproduction apparatus 100 via the interface control circuit 108.

At step S1, the CPU 106 controls the pickup 103 to irradiate a laser beam onto the four-layered BD-R 200. Subsequently, at step S2, the CPU 106 controls the servo circuit 104 to rotate the spindle motor 102. Subsequently, at step S3, the servo circuit 104 controls the tracking and focus to enable the reproduction of data.

Subsequently, at step S4, the CPU 106 controls the servo circuit 104 so as to access the control data area. Subsequently, at step S5, the CPU 106 controls the recording/reproduction circuit 105 to reproduce the control data, and acquires the control data.

Subsequently, at step S6, the CPU 106 acquires the number of recording layers of the loaded optical disk from the control data. The CPU 106 thereafter decides the limiting value N of the number of recording layers including a recorded area based on the acquired number of recording layers.

Here, in the first embodiment, the guaranteeable range of the recording quality shall be up to 2 layers. Specifically, if the number of recording layers of the loaded optical disc is 2 layers or less, it will be N=0, and if the number of recording layers of the loaded optical disc is 3 layers or more, it will be N=1. Accordingly, since the four-layered BD-R 200 is loaded in the first embodiment, it will be N=1.

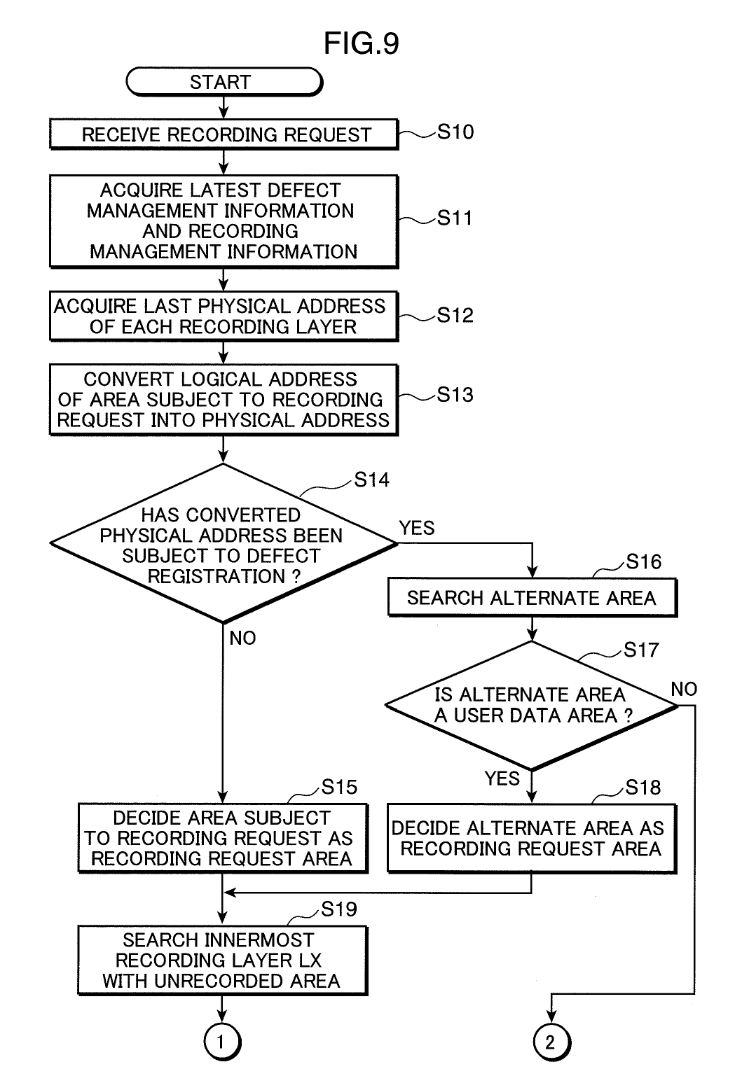

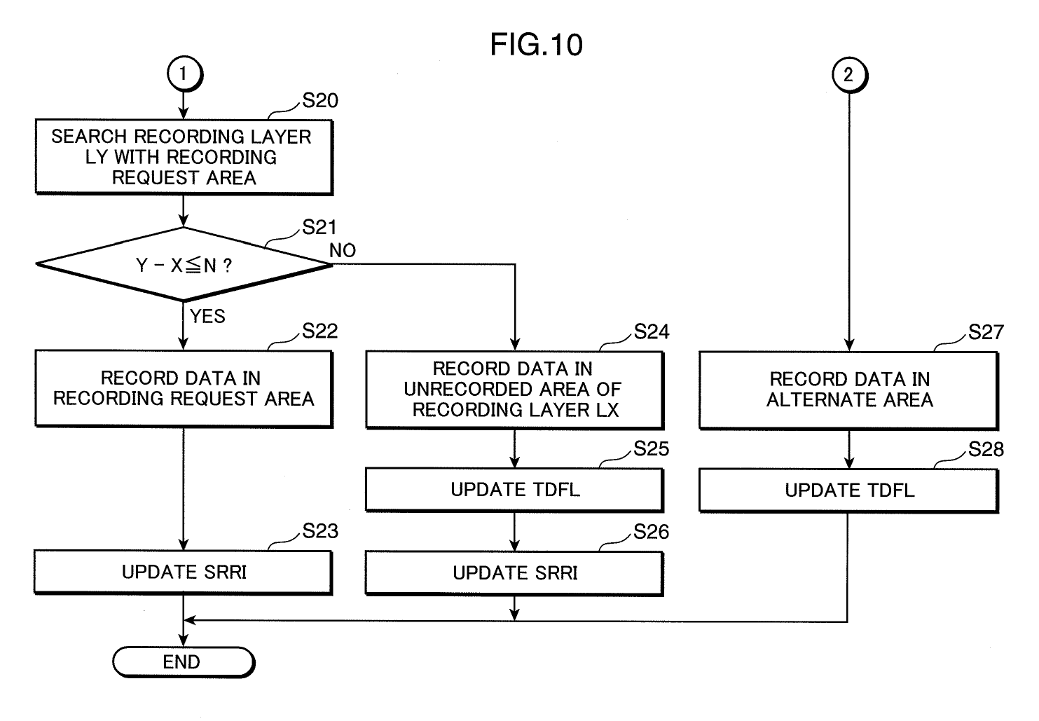

The recording method according to the first embodiment of the present invention is now explained. FIG. 9 and FIG. 10 are flowcharts showing the recording method according to the first embodiment of the present invention.

The host apparatus 109 designates the logical address and the size of the area for recording data, and issues a recording command to the information recording/reproduction apparatus 100 via the interface control circuit 108.

Foremost, at step S10, the CPU 106 receives the recording command (recording request) that was issued by the host apparatus 109. Subsequently, at step S11, the CPU 106 controls the servo circuit 104 to cause the pickup 103 to access the DMA or the TDMA in the inner zone of the respective recording layers. Subsequently, the CPU 106 controls the recording/reproduction circuit 105 to reproduce data from the DMA or the TDMA, and acquires the latest defect management information and the recording management information from the optical disc 101.

Subsequently, at step S12, the CPU 106 controls the servo circuit 104 to cause the pickup 103 to access the area storing the last physical address of the respective recording layers in the inner zone 201 of the first recording layer L0. Subsequently, the CPU 106 controls the recording/reproduction circuit 105 and acquires the last physical address of the respective recording layers.

Subsequently, at step S13, the CPU 106 converts the logical address of an area for storing data as designated by the host apparatus 109 into a physical address.

Subsequently, at step S14, the CPU 106 compares the latest defect management information acquired at step S11 and the converted physical address, and determines whether the converted physical address has been subject to defect registration. If it is determined that the converted physical address has not been subject to defect registration (step S14; NO), the routine proceeds to the processing of step S15. Meanwhile, it is determined that the converted physical address has been subject to defect registration (step S14; YES), the routine proceeds to the processing of step S16.

If it is determined that the converted physical address has not been subject to defect registration, at step S15, the CPU 106 decides the area subject to the recording request as the recording request area, and executes the subsequent processing.

If it is determined that the converted physical address has been subject to defect registration, at step S16, the CPU 106 searches an alternate area based on the defect management method. Since the defect management method is stipulated in the specification, the explanation thereof is omitted.

Subsequently, at step S17, the CPU 106 determines whether the alternate area sought at step S16 is a user data area. If it is determined that the alternate area is a user data area (step S17; YES), the routine proceeds to the processing of step S18. Meanwhile, if it is determined that the alternate area is not a user data area (step S17; NO), the routine proceeds to the processing of step S27.

If it is determined that the alternate area is a user data area, at step S18, the CPU 106 decides the alternate area as the recording request area, and executes the subsequent processing.

Subsequently, at step S19, the CPU 106 searches a recording layer LX which is innermost from the optical entrance surface of the optical disc among recording layers which have an unrecorded area. Incidentally, the detailed method of searching the recording layer LX which is innermost from the optical entrance surface of the optical disc among recording layers which have an unrecorded area will be explained later.

Subsequently, at step S20, the CPU 106 searches a recording layer LY including the recording request area. Specifically, the CPU 106 determines whether the first physical address of the recording request area is smaller than the last physical address of the respective recording layers. The CPU 106 determines the recording layer in which the first physical address of the recording request area is smaller than the last physical address as the recording layer LY including the recording request area. Consequently, the layer number Y of the recording layer LY including the recording request area can be sought.

Subsequently, at step S21, the CPU 106 determines whether the difference between the layer number Y of the recording layer LY including the recording request area and the layer number X of the recording layer LX which is innermost from the optical entrance surface of the optical disc among recording layers which have an unrecorded area is the limiting value N or less of the number of recording layers including a recorded area. If it is determined that the difference between the layer number Y and the layer number X is the limiting value N or less; that is, if it is determined that the recording request area is within a recordable range (step S21; YES), the routine proceeds to the processing of step S22. Meanwhile, if it is determined that the difference between the layer number Y and the layer number X is not the limiting value N or less; that is, if it is determined that the recording request area is outside the recordable range (step S21; NO), the routine proceeds to the processing of step S24.

If it is determined at step S21 that the recording request area is within a recordable range; that is, if it is determined that the data is recordable in the recording request area, at step S22, the CPU 106 controls the servo circuit 104 to cause the pickup 103 to access the recording request area. Subsequently, the CPU 106 controls the recording/reproduction circuit 105 to record data in the recording request area, and proceeds to the processing of step S23.

Subsequently, at step S23, the CPU 106 updates the LRA of the recorded SRR to the last address of the recording request area, and controls the recording/reproduction circuit 105 to record the updated SRRI and TDDS in the TDMA 303.

If it is determined at step S21 that the recording request area is outside the recordable range; that is, if it is determined that data cannot be recorded in the recording request area, at step S24, the CPU 106 records data in an unrecorded area within a recordable range. Specifically, the CPU 106 controls the servo circuit 104 to cause the pickup 103 to access an unrecorded area of the smallest SRR number i (SRR #i) within the Open SRR, which is an unrecorded area of the recording layer LX which is innermost from the optical entrance surface of the optical disc among recording layers which have an unrecorded area. Subsequently, the CPU 106 controls the recording/reproduction circuit 105 to record data in the unrecorded area of the SRR #1 in the recording layer LX which is innermost from the optical entrance surface of the optical disc among recording layers which have an unrecorded area, and then proceeds to the processing of step S25.

Subsequently, at step S25, the CPU 106 sets the first physical address of the recording request area in the defect physical address 522 of the DFL Entry, sets the first physical address of the area recorded in the SRR #i in the physical address 524 of the alternate destination, and sets the value of “1111” showing that the alternate source is unrecorded in the status information 521.

Here, if the recording request area is one cluster, the CPU 106 creates a DFL Entry in which the value of “0000” showing the defect of one cluster is set in the status information 523. If the recording request area is a consecutive area, the CPU 106 creates a DFL Entry in which the value of “0001” showing the start of the consecutive defect cluster is set in the status information 523. Similarly, the CPU 106 creates a DFL Entry showing the last physical address of the recording request area. The CPU 106 adds the created DFL Entry to the latest TDFL, and proceeds to the processing of step S26.

Subsequently, at step S26, the CPU 106 updates the LRA of the recorded SRR #i to the last address of the recorded area, and controls the recording/reproduction circuit 105 to record the updated TDFL and SRRI and TDDS in the TDMA 303.

Moreover, if it is determined at step S17 that the alternate area is not a user data area; that is, if it is determined that the alternate area is a spare area, at step S27, the CPU 106 controls the servo circuit 104 to cause the pickup 103 to access the alternate area. Subsequently, the CPU 106 controls the recording/reproduction circuit 105 to record data in the alternate area, and then proceeds to the processing of step S28.

Subsequently, at step S28, the CPU 106 creates a DFL Entry based on the well-known defect management method, and adds it to the latest TDFL. Subsequently, the CPU 106 controls the recording/reproduction circuit 105 to record the updated TDFL and TDDS in the TDMA 303.

As described above, according to the recording method of the first embodiment, data can be recorded while guaranteeing the recording quality by determining whether there is a recording request area in an area within the recordable range between a recording layer which is innermost from the optical entrance surface of the optical disc among recording layers which have an unrecorded area, and a recording layer capable of guaranteeing the recording quality, and, if the recording request area is outside the recordable range, alternatively recording the data in an area within a recordable range.

Moreover, according to the configuration of the first embodiment, it is possible to receive a recording request for recording information on an optical disc including two or more recording layers. In addition, information is recorded by, limiting the number of recording layers including an area with information recorded thereon to a predetermined value N (N≧0) or less with respect to other recording layers in which light passes therethrough until the light reaches an unrecorded area of a recording layer as a recording target.

Accordingly, since the number of recording layers including an area with information recorded thereon is limited to a predetermined value N (N≧0) or less with respect to other recording layers in which light passes therethrough until the light reaches an unrecorded area of a recording layer as a recording target, it is possible to reduce the influence that the light which reaches an unrecorded area of a recording layer as a recording target will receive from the optical characteristics of other recording layers, and guarantee the recording quality of the multilayered optical disc.

Moreover, in the first embodiment, the alternate area is an unrecorded area in a recording layer which is innermost from the optical entrance surface of the optical disc among recording layers which have an unrecorded area. As a result of alternatively recording information on a recording layer which is innermost from the optical entrance surface of the optical disc among recording layers which have an unrecorded area, the recording layer closer to the side of the optical entrance surface than the recording layer which is innermost from the optical entrance surface of the optical disc among recording layers which have an unrecorded area in which light passes therethrough can be kept unrecorded. Consequently, it is possible to minimize the influence caused by the other recording layers in which light passes therethrough. Moreover, since all areas will be recorded in order from the recording layer which is innermost from the optical entrance surface of the optical disc, the recordable range can be spread quickly. In addition, the unrecorded area of the recording layer which is innermost from the optical entrance surface of the optical disc can be easily sought by searching the smallest SRR number among the Open SRRs.

In addition, the information recording/reproduction apparatus of the first embodiment is able to record data in any area so as long as it is within a recordable range.

Moreover, since an area outside the recordable range is not registered as a defect, data is recorded regardless of which area is subject to the recording request. Thus, since error based on the prohibition of recording will not arise and the unused capacity of the optical disc will not increase, the processing of the host apparatus will not be affected.

Moreover, as a result of alternatively recording data in an area within a recordable range, the recording in the logical space will not change, whereby the processing of the host apparatus will not be affected.

Moreover, as a result of recording data in an area within a recordable range, the recording layers in which a recorded area and an unrecorded area coexist can be limited, and a prescribed power margin can be secured.

Incidentally, in the first embodiment, although step S20 of FIG. 10 searches the layer number Y of the recording layer LY including the recording request area by using the first physical address of the recording request area and the last physical address of the respective recording layers, the present invention is not limited to this method so as long as it is possible to search the layer number Y of the recording layer LY including the recording request area. For instance, the layer number Y may also be sought from the layer number included in the first physical address of the recording request area. Consequently, the layer number Y of the recording layer LY including the recording request area can be sought even faster.

Moreover, if a spare area or a TDMA is allocated to the data area, it is also possible to search the layer number Y of the recording layer LY including the recording request area by searching the last physical address capable of recording user data of the respective recording layers based on the last physical address of the respective recording layers and the size of the allocated spare area or TDMA, and comparing the first physical address of the recording request area and the last physical address capable of recording user data of the respective recording layers. Consequently, the layer number Y of the recording layer LY including the recording request area can be sought even more accurately.

Incidentally, in the first embodiment, although step S20 and step S21 of FIG. 10 determine whether the recording request area is within a recordable range by searching the layer number Y of the recording layer including the recording request area and determining whether Y−X≦N, the present invention is not limited thereto, and other methods may be used so as long as it is possible to determine whether the recording request area is within a recordable range. For example, whether the first physical address of the recording request area is smaller than the last physical address of the recording layer L (X+N) corresponding to the layer number obtained by adding the limiting value N to the layer number X of the recording layer which is innermost from the optical entrance surface of the optical disc among recording layers which have an unrecorded area may also be determined.

Incidentally, in the first embodiment, although step S24 of FIG. 10 alternatively records data in an unrecorded area of the smallest SRR number i (SRR #i) among the Open SRRs, the area of the alternate destination is not limited thereto and will suffice so as long as it is an area within a recordable range. For example, data may be recorded in an area where all areas to be recorded can be recorded consecutively. Consequently, consecutive access is enabled, and the performance during the reproduction will improve.

Data may also be recorded in the SRR with the largest unrecorded area. Consequently, since it is highly likely that data can be recorded in the same SRR, management of the SRR is facilitated and consecutive access will also be possible. Moreover, data may also be recorded in the SRR with the smallest unrecorded area after the alternate recording. Consequently, it will be possible to leave a consecutive unrecorded area.

Moreover, data may also be recorded in an area that is close to the same radial position as the recording request area. Consequently, the seek time can be shortened. In addition, data may also be recorded in the SRR with the smallest unrecorded area. Consequently, the number of Open SRRs can be reduced, and management of SRR is facilitated.

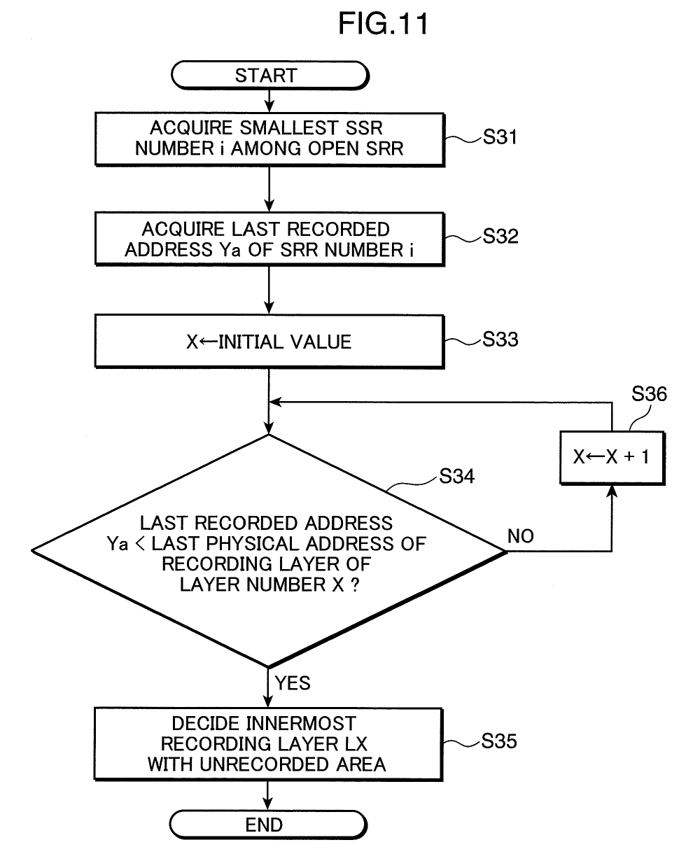

The processing of step S19 in FIG. 9 of searching the recording layer LX which is innermost from the optical entrance surface of the optical disc among recording layers which have an unrecorded area is now explained with reference to FIG. 11. FIG. 11 is a flowchart showing the processing of searching the recording layer which is innermost from the optical entrance surface of the optical disc among recording layers which have an unrecorded area according to the first embodiment of the present invention.

Foremost, at step S31, the CPU 106 acquires the smallest SRR number i from the list showing the Open SRR numbers of the latest recording management information.

Subsequently, at step S32, the CPU 106 acquires the last recorded address Ya of the SRR #i of the SRR number i that was acquired at step S31 from the latest recording management information.

Subsequently, at step S33, the CPU 106 sets the layer number X to the initial value 0, and executes the subsequent processing.

Subsequently, at step S34, the CPU 106 determines whether the last recorded address Ya of the SRR #i is smaller than the last physical address of the recording layer corresponding to the layer number X. Here, if it is determined that the last recorded address Ya is smaller than the last physical address of the recording layer of the layer number X (step S34; YES), at step S35, the CPU 106 decides the recording layer corresponding to the current layer number X as the recording layer LX which is innermost from the optical entrance surface of the optical disc among recording layers which have an unrecorded area.

Meanwhile, if it is determined that the last recorded address Ya is not smaller than the last physical address of the recording layer of the layer number X; that is, if it is determined that the last recorded address Ya is greater than the last physical address of the recording layer LX (step S34; NO), at step S36, the CPU 106 increments the layer number X, and executes the processing of step S34.

As described above, since the SRR number is allocated in ascending order from the area of the recording layer that is more on the inner side than the optical entrance surface of the optical disc, an unrecorded area of the recording layer which is innermost from the optical entrance surface of the optical disc can be sought by acquiring the smallest SRR number among the Open SRRs. Moreover, the recording layer in which the unrecorded area exists can be sought by comparing the last physical address and the last recorded address of the respective recording layers. As described above, as a result of using the recording management information, the recording layer which is innermost from the optical entrance surface of the optical disc among recording layers which have an unrecorded area can be sought faster than searching an unrecorded area by actually irradiating light.

Incidentally, in the first embodiment, although step S33 of FIG. 11 set 0 as the initial value of the layer number X, the present invention is not limited thereto. Upon searching the recording layer LX which is innermost from the optical entrance surface of the optical disc among recording layers which have an unrecorded area, the layer number X corresponding to the recording layer LX may be retained, and, when the recording layer LX is to be subsequently sought, the retain layer number X may be set as the initial value. Moreover, the layer number included in the last recorded address Ya may also be set as the initial value. Consequently, the recording layer which is innermost from the optical entrance surface of the optical disc among recording layers which have an unrecorded area can be sought even faster.

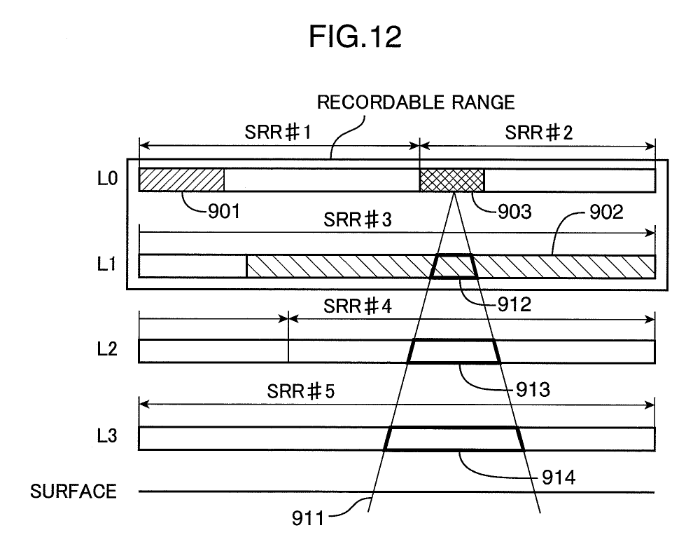

The recording status of the four-layered BD-R 200 recorded with the recording method of the first embodiment is now explained with reference to FIG. 12 to FIG. 14. FIG. 12 to FIG. 14 are diagrams showing an example of the recording state of the four-layered BD-R 200 recorded with the recording method according to the first embodiment of the present invention.

In FIG. 12, in the case of a brand new four-layered BD-R, the recording layer which is innermost from the optical entrance surface of the optical disc among recording layers which have an unrecorded area will be the first recording layer L0. Since the limiting value N of the number of recording layers including a recorded area is 1, the area within a recordable range will be the areas of the first recording layer L0 and the second recording layer L1. Accordingly, if the host apparatus 109 issues a recording request to the area 901 of the first recording layer L0 or the area 902 of the second recording layer L1, since the areas of the first recording layer L0 and the second recording layer L1 are within a recordable range, data will be recorded in the areas 901, 902 as the recording request area.

Subsequently, in the case of a four-layered BD-R in which the area 901 and the area 902 have been recorded, since the first recording layer L0 has an unrecorded area, as with the brand new four-layered BD-R, the area within a recordable range will be the areas of the first recording layer L0 and the second recording layer L1. Accordingly, if the host apparatus 109 issues a recording request to the area 903 of the first recording layer L0, since the area of the first recording layer L0 is within a recordable range, data will be recorded in the area 903 as the recording request area.

When data is recorded in the area 903, the optical beam 911 will pass through the area 912 of the second recording layer L1, the area 913 of the third recording layer L2, and the area 914 of the fourth recording layer L3, and condense on the area 903. According to the recording method of the first embodiment, since data will be recorded in the area 903, the recording layer as the recorded area can be limited to a single layer of the second recording layer L1 including the area 912. Thus, recording can be performed while guaranteeing the recording quality in the area 903.

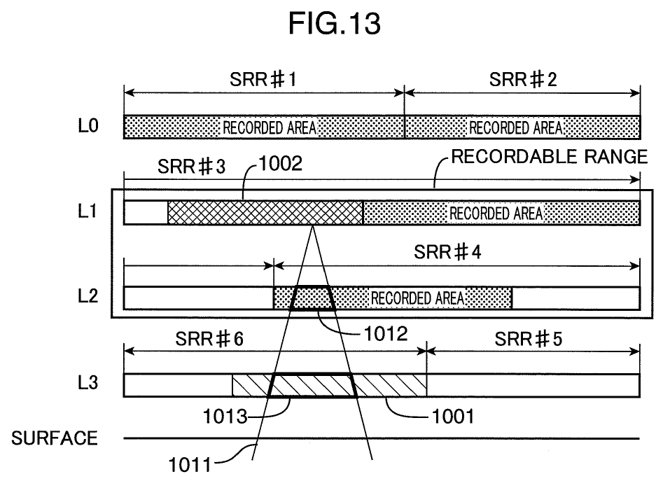

A four-layered BD-R having a recording status where all areas of the first recording layer L0 have been recorded, and partial areas of the second recording layer L1 and the third recording layer L2 have been respectively recorded is now explained with reference to FIG. 13.

In the foregoing case, since the recording layer which is innermost from the optical entrance surface of the optical disc among recording layers which have an unrecorded area will be the second recording layer L1, the area within a recordable range will be the areas of the second recording layer L1 and the third recording layer L2. If the host apparatus 109 issues a recording request to the area 1001 of the fourth recording layer L3, since the area 1001 is outside the recordable range, data will be alternatively recorded in the unrecorded area 1002 of the second recording layer L1.

When data is recorded in the area 1002, the optical beam 1011 will pass through the area 1012 of the third recording layer L2, and the area 1013 of the fourth recording layer L3, and condense on the area 1002. If data is recorded on the area 1001 as conventionally, the area 1012 and the area 1013 will become recorded, and the number of recording layers including a recorded area will become 2 and exceed the limiting value N. According to the recording method of the first embodiment, since data is alternatively recorded in the area 1002, the area 1001 will remain an unrecorded area, and the recording layer as the recording area in which light passes therethrough upon recording data in the area 1002 can be limited to a single layer of the third recording layer L2 including the area 1012. Thus, recording can be performed while guaranteeing the recording quality in the area 1002.

Moreover, since the recordable range is sought from the recording layer which is innermost from the optical entrance surface of the optical disc among recording layers which have an unrecorded area, the third recording layer L2 that was outside the recordable range with a brand new optical disc will be within a recordable range. Thus, it will not be necessary to perform alternate recording in the recording of information in the third recording layer L2, and the processing is thereby simplified.

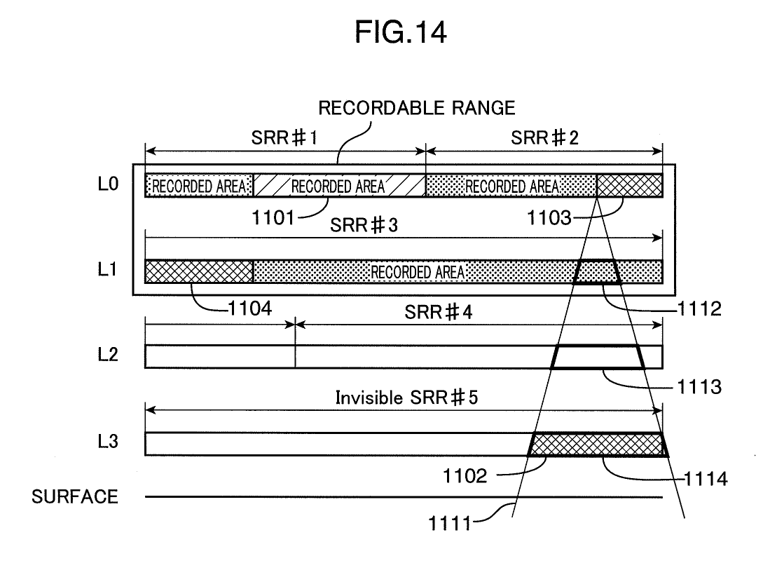

A four-layered BD-R having a recording status in which partial areas of the first recording layer L0 and the second recording layer L1 have been respectively recorded is now explained with reference to FIG. 14. In the foregoing case, since the recording layer which is innermost from the optical entrance surface of the optical disc among recording layers which have an unrecorded area will be the first recording layer L0, the area within a recordable range will be the areas of the first recording layer L0 and the second recording layer L1.

In the case of a BD-R, since recording (Logical OverWrite) is performed to a previously recorded area, the information recording/reproduction apparatus receives a recording request to the recorded area. When the host apparatus 109 issues a recording request to the recorded area 1101, the CPU 106 searches the alternate area 1102. According to the recording method of the first embodiment, since the alternate area 1102 of the fourth recording layer L3 is an area outside the recordable range, data will be alternatively recorded in the area 1103 of the first recording layer L0 and the area 1104 of the second recording layer L1 within a recordable range.

When data is recorded in the area 1103 of the first recording layer L0, the optical beam 1111 will pass through the area 1112 of the second recording layer L1, the area 1113 of the third recording layer L2, and the area 1114 of the fourth recording layer L3, and condense on the area 1103. If data is recorded in the area 1102 as conventionally, the area 1112 and the area 1114 will become recorded, and the number of recording layers including a recorded area will become 2 and exceed the limiting value N.

According to the recording method of the first embodiment, since data is alternatively recorded in the area 1103 and the area 1104, the area 1102 will remain an unrecorded area. Accordingly, the recording layer as the recording area in which light passes therethrough upon recording data in the area 1103 can be limited to a single layer of the second recording layer L1 including the area 1112. Thus, recording can be performed while guaranteeing the recording quality in the area 1103. As described above, since data is alternatively recorded in a recordable range even regarding the recording of data in an area of the alternate destination based on alternate recording, it is possible to guarantee the recording quality of all areas of all recording layers of the optical disc.

Incidentally, although the present embodiment explains a case where one DMA is provided to each inner zone and each outer zone, and one TDMA is provided for each inner zone, as long as there is an area for storing the defect management information and the recording management information, the present invention is not limited thereto. For example, a plurality of DMAs and TDMAs may be provided to the respective zones or the respective recording layers. In addition, only one of either the DMA or the TDMA may exist. Moreover, it will suffice so as long as at least one DMA or one TDMA is provided to one of the recording layers.

Moreover, although the last physical address of the respective recording layers is stored in the inner zone of the first recording layer L0, the present invention is not limited thereto. For example, the last physical address of the respective recording layers may also be stored in the inner zone or outer zone of the respective recording layers. Moreover, the last physical address of the respective recording layers may also be stored in the outer zone of the first recording layer L0. In addition, the last physical address of the respective recording layers may also be included in the control data.

Although the first embodiment decided the limiting value N based on the number of recording layers included in the control data, the present invention is not limited thereto. For example, the limiting value N may also be decided based on information concerning the version of the optical disc or the capacity of the optical disc. Moreover, if the limiting value N is to be pre-recorded as control data, it may also be decided based on the value thereof.

Specifically, the control data may also include a recordable limiting value representing the number of recording layers in which the recording quality of recording layers including an area with information recorded thereon is guaranteed, and the limiting value decision unit 12 may decide the limiting value N based on the recordable limiting value. Moreover, the limiting value decision unit 12 may also decide the limiting value N based on the number of recording layers of the optical disc 101.

Moreover, although the first embodiment decided the limiting value N based only on the number of recording layers, the present invention is not limited thereto. The limiting value decision unit 12 may also decide the limiting value N based on the version information representing the type of optical disc 101. For example, the limiting value decision unit 12 may decide the limiting value N based on a plurality of pieces of information such as by combining the number of recording layers and the version information, or by combining the version information and the disc type.

Although the first embodiment guarantees the recording quality up to 2 layers, the present invention is not limited thereto. For example, the number of recording layers in which the recording quality can be guaranteed can be decided arbitrarily according to the characteristics of the recording medium or the recording film. Moreover, the number of recording layers in which the recording quality can be guaranteed may also be arbitrarily decided according to the characteristics of the information recording/reproduction apparatus such as the laser and servo, or the type of data to be recorded such as recording of streaming contents or recording of PC data. In addition, the number of recording layers in which the recording quality can be guaranteed may also be variable rather than being fixed within a range capable of guaranteeing the recording quality.

In the first embodiment, although data is recorded in the continuous recording mode, so as long as alternate overwrite is possible, the present invention is not limited thereto. Specifically, data may also be recorded via the random recording mode.

In the first embodiment, although the optical disc was a four-layered BD-R, the present invention is not limited thereto. For example, any number of layers may be adopted so as long as it is 2 layers or more. In addition, a rewritable optical disc may also be used.

Incidentally, although the latest defect management information and the recording management info ration are acquired after receiving the recording command at step S10 of FIG. 9, the timing of acquiring the latest defect management information and the recording management information is not limited thereto. For example, the defect management information and the recording management information may be acquired at the start-up of the information recording/reproduction apparatus, and the defect management information and the recording management information updated to the latest information may be used. Moreover, the defect management information and the recording management information may also be acquired separately as needed.

Incidentally, in the first embodiment, if it is determined at step S17 of FIG. 9 that the alternate area is not a user data area, data is recorded in the alternate area at step S27 of FIG. 10, and the area to be used in determining whether the limiting value N is satisfied is the user data area, but the present invention is not limited thereto. For example, at step S27, when data is recorded in the alternate area, whether the limiting value N is satisfied in the spare area may be determined, and the alternate area may be changed to the area that satisfies the limiting value N. Moreover, when recording data in the inner zones 201 to 204 and the outer zones 221 to 224, this may also be applied to the inner zones and the outer zones. Consequently, information can be recorded while guaranteeing the recording quality in all areas of the optical disc 101.

### Second Embodiment

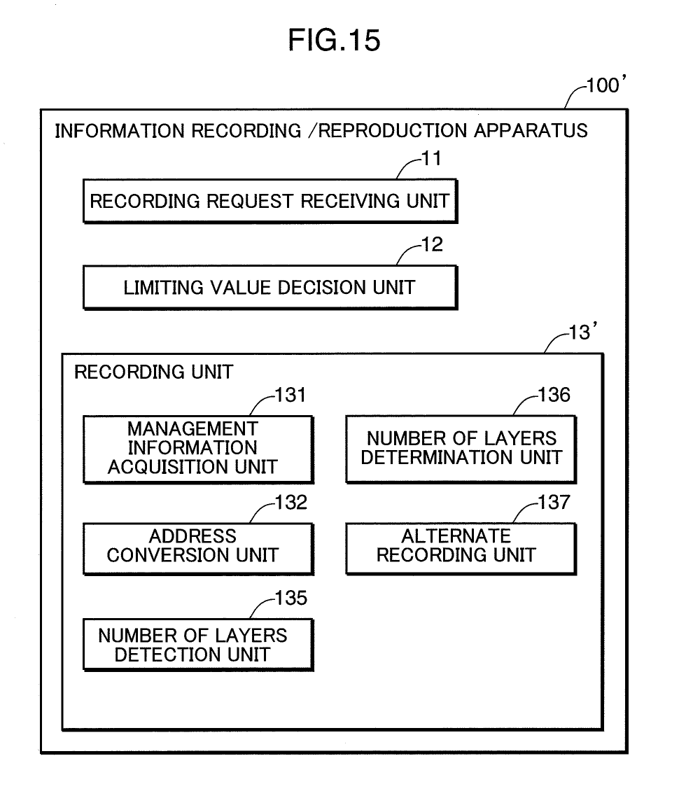

In the second embodiment of the present invention, a different recording method for recording data on the four-layered BD-R 200 is explained with reference to FIG. 15 to FIG. 20. Here, the four-layered BD-R 200 of the second embodiment shall be within a range of being able to guarantee the recording quality up to 2 layers as with the first embodiment. Accordingly, the limiting value N of the number of recording layers including a recorded area will be 1.

FIG. 15 is a block diagram showing the functional configuration of an information recording/reproduction apparatus 100′ according to the second embodiment of the present invention. The information recording/reproduction apparatus 100′ comprises a recording request receiving unit 11, a limiting value decision unit 12 and a recording unit 13′. Incidentally, in the second embodiment, the information recording/reproduction apparatus 100′ corresponds to an example of the information recording apparatus. Moreover, with the information recording/reproduction apparatus 100′ depicted in FIG. 15, the same configuration as the information recording/reproduction apparatus 100 of the first embodiment is given the same reference numeral, and the explanation thereof is omitted.

The recording unit 13′ comprises a management information acquisition unit 131, an address conversion unit 132, a number of layers detection unit 135, a number of layers determination unit 136, and an alternate recording unit 137. Incidentally, the spindle motor 102, the pickup 103, the servo circuit 104, the recording/reproduction circuit 105, the CPU 106, the buffer memory 107 and the interface control circuit 108 of FIG. 1 function as the recording unit 13′.

The number of layers detection unit 135 detects the number of recording layers including an area in the same radial position as the recording request area that was subject to the recording request and with information recorded thereon among the respective recording layers located on the side of the optical entrance surface from a recording layer which is innermost from an optical entrance surface of the information recording medium among recording layers which have an unrecorded area. The number of layers determination unit 136 determines whether the number of recording layers detected with the number of layers detection unit 135 is the limiting value N or higher.

If the detected number of recording layers is determined to be the predetermined value N or higher, the alternate recording unit 137 decides an unrecorded area existing between the recording layer which is innermost from the optical entrance surface of the optical disc among recording layers which have an unrecorded area and the recording layer that is closer to the side of the optical entrance surface for the limiting value N from the recording layer which is innermost from the optical entrance surface of the optical disc among recording layers which have an unrecorded area as the alternate area, and records the information to be recorded in the recording request area in the alternate area.

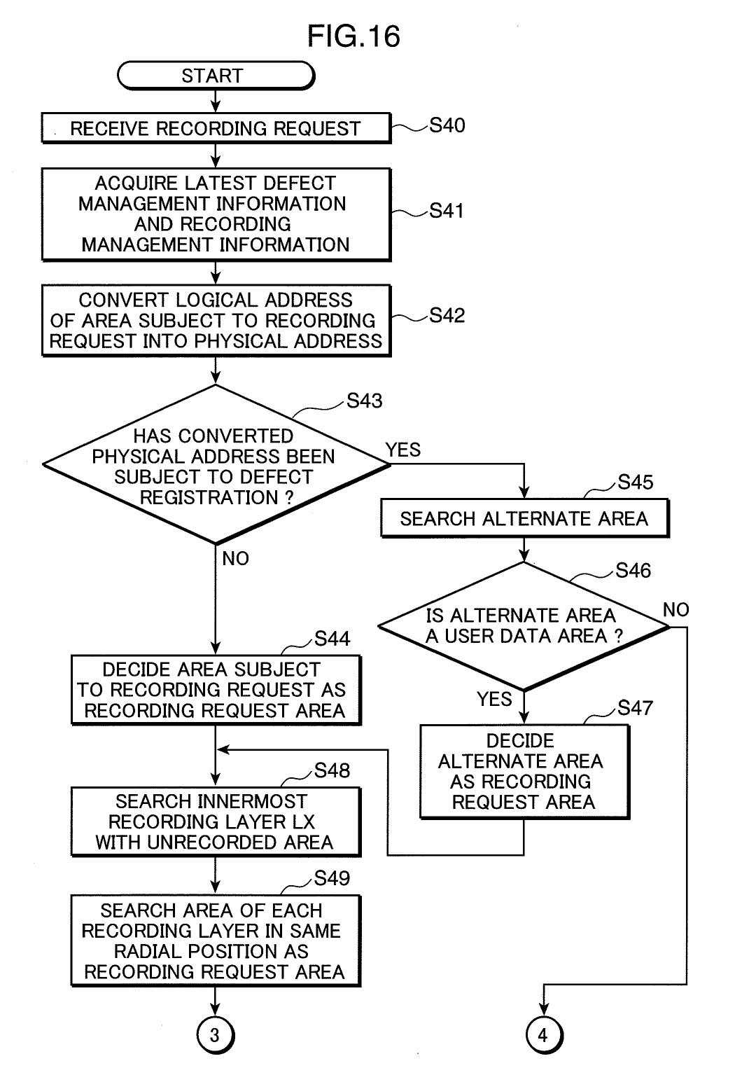

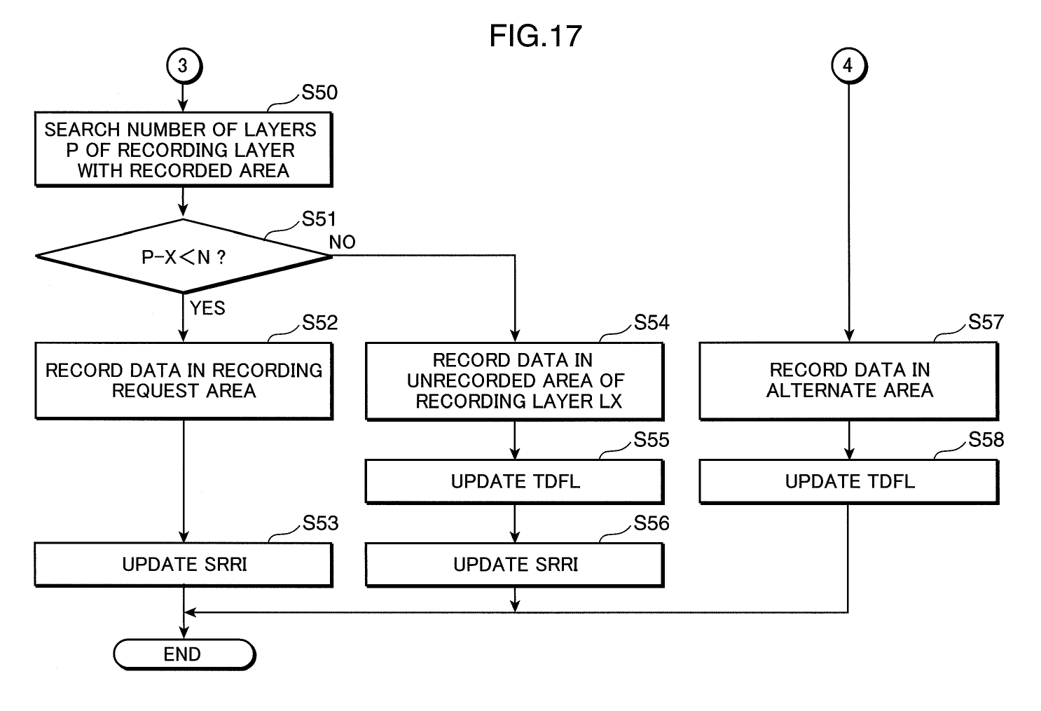

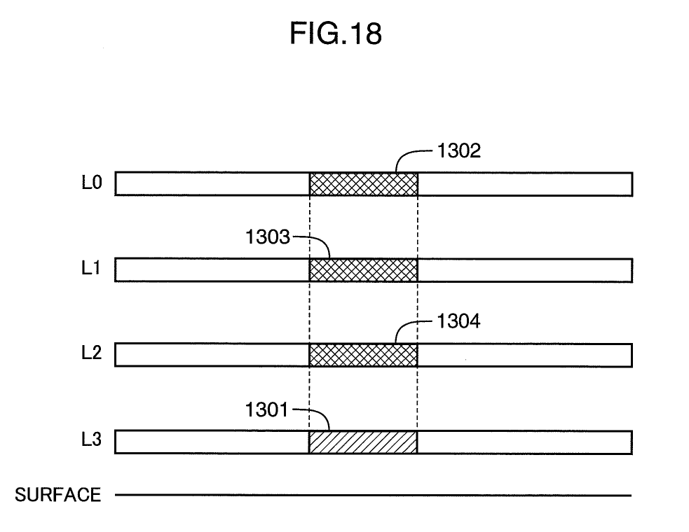

FIG. 16 and FIG. 17 are flowcharts showing the recording method according to the second embodiment of the present invention. Incidentally, the processing of steps S40, S41 to S48, S52 to S58 in FIG. 16 and FIG. 17 is the same as the processing of steps S10, S11, S13 to S19, S22 to S28 shown in FIG. 9 and FIG. 10, and the detailed explanation thereof is omitted. FIG. 18 is a diagram explaining the recording of data in the same radial position according to the second embodiment of the present invention.

The host apparatus 109 designates the logical address and the size of the area for recording data, and issues a recording command to the information recording/reproduction apparatus 100 via the interface control circuit 108.

Foremost, at step S40, the CPU 106 receives the recording command (recording request) that was issued by the host apparatus 109. Subsequently, at step S41, the CPU 106 acquires the latest defect management information and the recording management information from the optical disc. Subsequently, at step S42, the CPU 106 converts the logical address of the area for recording the data as designated by the host apparatus 109 into a physical address.

Subsequently, at step S43, the CPU 106 determines whether the converted physical address has been subject to defect registration. If it is determined that the converted physical address has not been registered (step S43; NO), the routine proceeds to the processing of step S44. Meanwhile, if it is determined that the converted physical address was been registered (step S43; YES), the routine proceeds to the processing of step S45.

If it is determined the converted physical address has not been subject to defect registration, at step S44, the CPU 106 decides the area subject to the recording request as the recording request area, and executes the subsequent processing. If it is determined that the converted physical address has been subject to defect registration, at step S45, the CPU 106 searches the alternate area based on the defect management method.

Subsequently, at step S46, the CPU 106 determines whether the alternate area is a user data area. If it is determined that the alternate area is a user data area (step S46; YES), the routine proceeds to the processing of step S47. Meanwhile, if it is determined that the alternate area is not a user data area (step S46; NO), the routine proceeds to the processing of step S57.

If it is determined that the alternate area is a user data area, at step S47, the CPU 106 decides the alternate area as the recording request area, and executes the subsequent processing. Subsequently, at step S48, the CPU 106 searches the recording layer LX which is innermost from the optical entrance surface of the optical disc among recording layers which have an unrecorded area. Incidentally, the area 1301 of FIG. 18 is hereafter explained as the recording request area.

Subsequently, at step S49, the CPU 106 searches the areas 1302, 1303, 1304 of the respective recording layers in the same radial position as the recording request area 1301.

Subsequently, at step S50, the CPU 106 determines whether there is a recorded area in the areas 1302, 1303, 1304 of the respective recording layers in the same radial position as the recording request area 1301, and searches the number of recording layers P including a recorded area. Incidentally, the method of determining whether there is a recorded area will be explained later in detail.

Subsequently, at step S51, the CPU 106 determines whether the difference between the number of recording layers P including a recorded area among the areas of the respective recording layers in the same radial position as the recording request area and the layer number X of the recording layer LX which is innermost from the optical entrance surface of the optical disc among recording layers which have an unrecorded area is smaller than the limiting value N of the number of recording layers including a recorded area. Specifically, the CPU 106 compares the difference between the number of recording layers P including a recorded area among the areas of the respective recording layers in the same radial position as the recording request area and the layer number X of the recording layer which is innermost from the optical entrance surface of the optical disc among recording layers which have an unrecorded area with the limiting value N of the number of recording layers including a recorded area, and determines whether the difference between the number of recording layers P and the layer number X is smaller than the limiting value N. Here, if it is determined that the difference between the number of recording layers P and the layer number X is smaller than the limiting value N (step S51; YES), the routine proceeds to the processing of step S52. Meanwhile, if it is determined that the difference between the number of recording layers P and the layer number X is not smaller than the limiting value N; that is, if it is determined that the difference between the number of recording layers P and the layer number X is the limiting value N or higher (step S51; NO), the routine proceeds to the processing of step S54.

If it is determined at step S51 that the difference between the number of recording layers P and the layer number X is smaller than the limiting value N; that is, if it is determined that the recording quality will be guaranteed even if data is recorded in the recording request area, at step S52, the CPU 106 controls the servo circuit 104 to cause the pickup 103 to access the recording request area. Subsequently, the CPU 106 controls the recording/reproduction circuit 105 to record data in the recording request area, and then proceeds to the processing of step S53.

Subsequently, at step S53, the CPU 106 updates the LRA of the recorded SRR to the last address of the recording request area, and controls the recording/reproduction circuit 105 to record the updated SRRI and TDDS in the TDMA 303.

If it is determined at step S51 that the difference between the number of recording layers P and the layer number X is not smaller than the limiting value N; that is, if it is determined that the recording quality cannot be guarantee if data is recorded in the recording request area, at step S54, the CPU 106 controls the servo circuit 104 to cause the pickup 103 to access an unrecorded area of the smallest SRR number i (SRR #i) among the Open SRR as the unrecorded areas of the recording layer LX which is innermost from the optical entrance surface of the optical disc among recording layers which have an unrecorded area. Subsequently, the CPU 106 controls the recording/reproduction circuit 105 to record data in an unrecorded area or the SRR #i in the recording layer LX which is innermost from the optical entrance surface of the optical disc among recording layers which have an unrecorded area, and then proceeds to the processing of step S55.

Subsequently, at step S55, the CPU 106 sets the first physical address of the recording request area in the defect physical address 522 of the DFL Entry, sets the first physical address of the area recorded in the SRR #i in the physical address 524 of the alternate destination, and sets the value of “1111” showing that the alternate source is unrecorded in the status information 521.

Here, if the recording request area is one cluster, the CPU 106 creates a DFL Entry in which the value of “0000” showing the defect of one cluster is set in the status information 523. If the recording request area is a consecutive area, the CPU 106 creates a DFL Entry in which the value of “0001” showing the start of the consecutive defect cluster is set in the status information 523. Similarly, the CPU 106 creates a DFL Entry showing the last physical address of the recording request area. The CPU 106 adds the created DFL Entry to the latest TDFL, and proceeds to the processing of step S56.

Subsequently, at step S56, the CPU 106 updates the LRA of the recorded SRR #i to the last address of the recorded area, and controls the recording/reproduction circuit 105 to record the updated TDFL and SRRI and TDDS in the TDMA 303.

Moreover, if it is determined at step S46 that the alternate area is not a user data area, at step S57, the CPU 106 controls the servo circuit 104 to cause the pickup 103 to access the alternate area. Subsequently, the CPU 106 controls the recording/reproduction circuit 105 to record data in the alternate area, and then proceeds to the processing of step S58.

Subsequently, at step S58, the CPU 106 creates a DFL Entry based on the well-known defect management method, and adds it to the latest TDFL. Subsequently, the CPU 106 controls the recording/reproduction circuit 105 to record the updated TDFL and TDDS in the TDMA 303.

As described above, according to the recording method of the second embodiment, data can be recorded while guaranteeing the recording quality since whether the number of recording layers including a recorded area among the areas of the respective layers in the same radial position as the recording request area satisfies the limitation, and, if the number of recording layers including a recorded area does not satisfy the limitation, the data to be recorded in the recording request area is alternatively recorded in the recording layer which is innermost from the optical entrance surface of the optical disc among recording layers which have an unrecorded area.

Moreover, as a result of determining the areas in the same radial position as the recording request area, the influence caused by recording data in the recording request area can be determined more strictly in comparison to the determination of the overall recording layer as explained in steps S20, S21 of FIG. 10.

Moreover, the information recording/reproduction apparatus of the second embodiment is able to record data in any recording layer so as long as the number of recording layers including a recorded area satisfies the limit.

Moreover, since an area outside the recordable range is not registered as a defect, data is recorded regardless of which area is subject to the recording request. Thus, since error based on the prohibition of recording will not arise and the unused capacity of the optical disc will not increase, the processing of the host apparatus will not be affected.

Moreover, as a result of alternatively recording data in an unrecorded area of the recording layer which is innermost from the optical entrance surface of the optical disc among recording layers which have an unrecorded area, the recording in the logical space will not change, whereby the processing of the host apparatus will not be affected.

Moreover, as a result of limiting the number of recording layers including a recorded area in relation to the areas of the respective recording layers in the same radial position as the recording request area in which light passes therethrough, the number of recording layers in which a recorded area and an unrecorded area coexist can be limited, and a prescribed power margin can be secured.

Incidentally, in the second embodiment, although step S52 of FIG. 17 alternatively records data in an unrecorded area of the smallest SRR number i (SRR #i) among the Open SRR, the present invention is not limited thereto. For example, data may be recorded in an unrecorded area that is closest to the area in the same radial position as the recording request area. Moreover, data may also be recorded in an unrecorded area in the recording layer L (X+N) corresponding to the layer number obtained by adding the limiting value N to the layer number X of the recording layer which is innermost from the optical entrance surface of the optical disc among recording layers which have an unrecorded area.

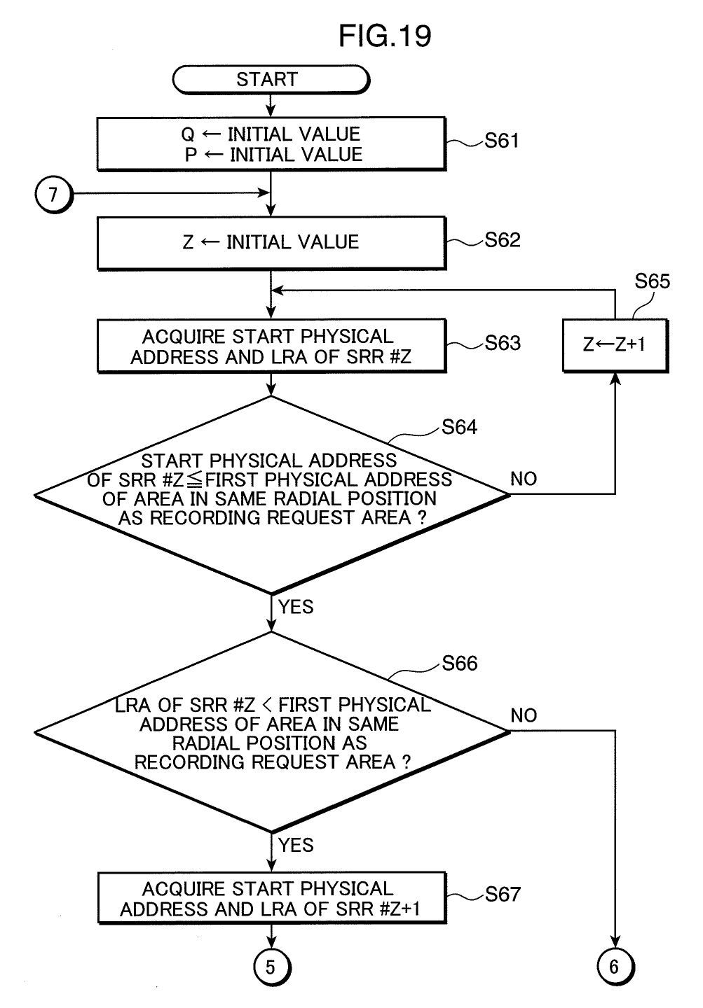

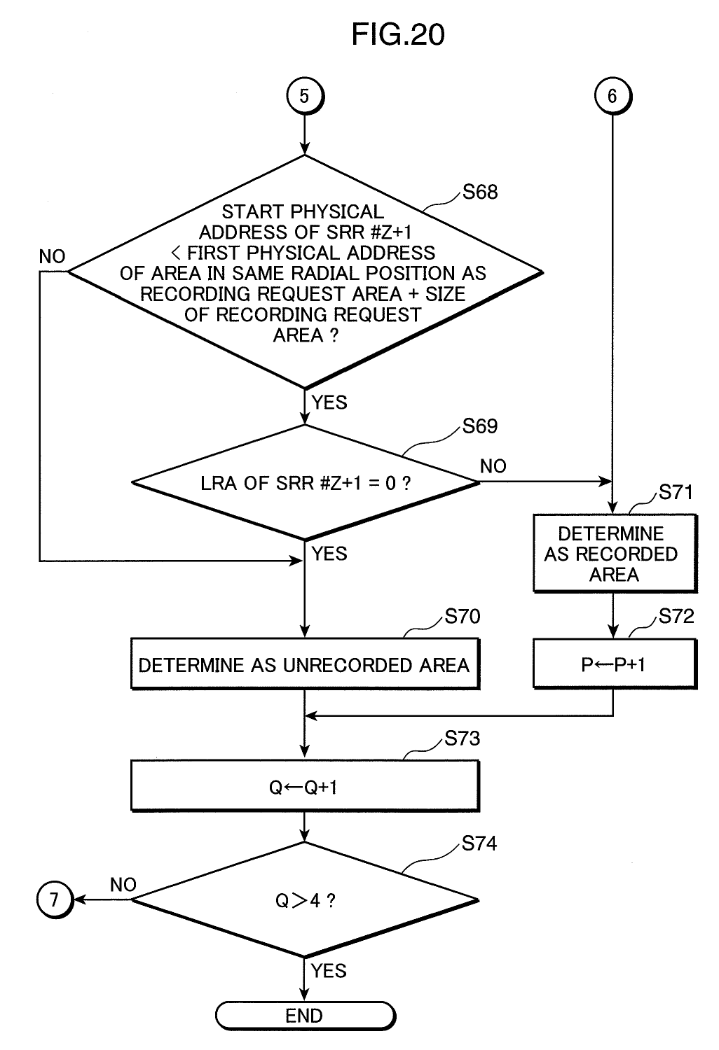

The processing of step S49 of FIG. 16 of determining whether there is a recorded area in the areas of the respective recording layers in the same radial position as the recording request area is now explained with reference to FIG. 19 and FIG. 20. FIG. 19 and FIG. 20 are flowcharts showing the processing of determining whether there is a recorded area in the areas of the respective recording layers in the same radial position as the recording request area according to the second embodiment of the present invention.

Foremost, at step S61, the CPU 106 sets the layer number Q of the recording layer LQ as the determination target and the number of recording layers P including a recorded area as the initial value 0. Incidentally, the layer number Q shall be 0, 1, 2, 3 in order from the recording layer that is farthest from the optical entrance surface of the optical disc.

Subsequently, at step S62, the CPU 106 sets the SRR number Z to the initial value 0, and executes the subsequent processing.

Subsequently, at step S63, the CPU 106 acquires the start physical address and the last recorded address (LRA) of the SRR #Z from the latest recording management information.

Subsequently, at step S64, the CPU 106 determines whether the start physical address of the SRR #Z is less than the first physical address of the area of the recording layer LQ in the same radial position as the recording request area. If it is determined that the start physical address of the SRR #Z is less than the first physical address of the area of the recording layer LQ in the same radial position as the recording request area; that is, if the area in the same radial position as the recording request area is in the SRR #Z (step S64; YES), the routine proceeds to the processing of step S66. Meanwhile, if it is determined that the start physical address of the SRR #Z is not less than the first physical address of the area in the same radial position as the recording request area (step S64; NO), the routine proceeds to the processing of step S65.

If it is determined that the start physical address of the SRR #Z is not less than the first physical address of the area in the same radial position as the recording request area, at step S65, the CPU 106 increments the SRR number Z, and returns to the processing of step S63.

If it is determined that the start physical address of the SRR #Z is less than the first physical address of the area of the recording layer LQ in the same radial position as the recording request area, the CPU 106 determines whether the last recorded address of the SRR #Z is smaller than the first physical address of the area of the recording layer LQ in the same radial position as the recording request area. If it is determined that the last recorded address of the SRR #Z is smaller than the first physical address of the area of the recording layer LQ in the same radial position as the recording request area; that is, if it is determined that the start position of the area in the same radial position as the recording request area is in an unrecorded area (step S66; YES), the routine proceeds to the processing of step S67.

Meanwhile, if it is determined that the last recorded address of the SRR #Z is not smaller than the first physical address of the area of the recording layer LQ in the same radial position as the recording request area; that is, if it is determined that the area in the same radial position as the recording request area includes a recorded area (step S66; NO), the routine proceeds to the processing of step S71.

If it is determined that the last recorded address of the SRR #Z is smaller than the first physical address of the area of the recording layer LQ in the same radial position as the recording request area, at step S67, the CPU 106 acquires the start physical address and the last recorded address of the SRR #Z+1 from the latest recording management information.

Subsequently, at step S68, the CPU 106 determines whether the start physical address of the SRR #Z+1 is smaller than the sum of the first physical address of the area in the same radial position as the recording request area and the size of the recording request area. If it is determined that the start physical address of the SRR #Z+1 is smaller than the sum of the first physical address of the area in the same radial position as the recording request area and the size of the recording request area; that is, if it is determined that the area in the same radial position as the recording request area is in the SRR #Z+1 (step S68; YES), the routine proceeds to the processing of step S69. Meanwhile, if it is determined that the start physical address of the SRR #Z+1 is not smaller than the sum of the first physical address of the area in the same radial position as the recording request area and the size of the recording request area; that is, if it is determined that the area in the same radial position as the recording request area will fit in the unrecorded area of the SRR #Z (step S68; NO), the routine proceeds to the processing of step S70.

Subsequently, at step S69, the CPU 106 determines whether the last recorded address of the SRR #Z+1 is equivalent to 0. If it is determined that the last recorded address of the SRR #Z+1 is equivalent to 0; that is, if the SRR #Z+1 is unrecorded and the area in the same radial position as the recording request area will fit in an unrecorded area (step S69; YES), the routine proceeds to the processing of step S70. Meanwhile, if it is determined that the last recorded address of the SRR #Z+1 is not equivalent to 0; that is, if the area in same radial position as the recording request area includes a recorded area (step S69; NO), the routine proceeds to the processing of step S71.

If it is determined that the last recorded address of the SRR #Z+1 is equivalent to 0, at step S70, the CPU 106 determines that the area in the same radial position as the recording request area is an unrecorded area.

Moreover, if it is determined that the last recorded address of the SRR #Z+1 is not equivalent to 0, or if it is determined at step S66 the last recorded address of the SRR #Z is not smaller than the first physical address of the area of the recording layer LQ in the same radial position as the recording request area, at step S71, the CPU 106 determines that the area in the same radial position as the recording request area includes a recorded area. Subsequently, at step S72, the CPU 106 increments the number of recording layers P including a recorded area.

Subsequently, at step S73, the CPU 106 increments the layer number Q of the recording layer LQ as the determination target. Subsequently, at step S74, the CPU 106 determines whether the layer number Q of the recording layer LQ as the determination target is greater than the number of all recording layers (4 in the second embodiment) of the optical disc. Here, if it is determined that the layer number Q is greater than the number of all recording layers of the optical disc (step S74; YES), since the determination of whether there is a recorded area has been performed for all recording layers of the optical disc, the processing is ended. Meanwhile, if it is determined that the layer number Q is less than the number of all recording layers of the optical disc (step S74; NO), the routine returns to the processing of step S62, and determination regarding whether there is a recorded area in the other recording layers is performed.

In the second embodiment, as a result of the processing of steps S62 to S72 being performed to the areas of the respective layers in the same radial position as the recording request area, it will be possible to search the number of recording layers P including a recorded area among the areas of the respective layers in the same radial position as the recording request area.

Incidentally, although 0 is used as the initial value to be set in the SRR number Z at step S62 of FIG. 19, it is also possible to acquire the smallest SRR number i from the list showing the Open SRR numbers of the latest recording management information, and use such number i as the initial value of the SRR number Z. In the foregoing case, the initial value of the number of recording layers P will be the layer number X+1 corresponding to the recording layer LX which is innermost from the optical entrance surface of the optical disc among recording layers which have an unrecorded area. Moreover, it is also possible to retain the SRR number Z upon searching the recorded status of a certain recording layer, and set the retained SRR number Z as the initial value upon subsequently searching the number of recording layers P.

Incidentally, although the initial value of the layer number Q of the recording layer LQ as the determination target is set to 0 at step S61 of FIG. 19, the layer number Q is incremented at step S73, and whether the layer number Q is greater than the number of all recording layers of the optical disc is determined at step S74, the present invention is not limited thereto. Since the recording request area is unrecorded, the determination of a recording layer in the recording request area may be skipped. Consequently, the number of recording layers P can be sought even faster.

Although the method of determining whether there is a recorded area in the areas of the respective layers in the same radial position as the recording request area according to the second embodiment performs the determination based on the recording management information, the present invention is not limited thereto and other methods may be used so as long as it is possible to determine whether there is a recorded area in the areas of the respective layers in the same radial position as the recording request area. For example, the determination may also be made based on a reproduction signal that is created by irradiating a laser beam onto the areas of the respective recording layers. For instance, the determination may also be made based on the size of the amplitude of the RF signal. Moreover, the determination may also be made based on whether the data can be property reproduced. In addition, the determination may be made based on whether the address can be property acquired. Furthermore, the determination may also be made by measuring the jitter value or the MLSE (Maximum Likelihood Sequence Estimation) value as the signal index, and with such value as the index.

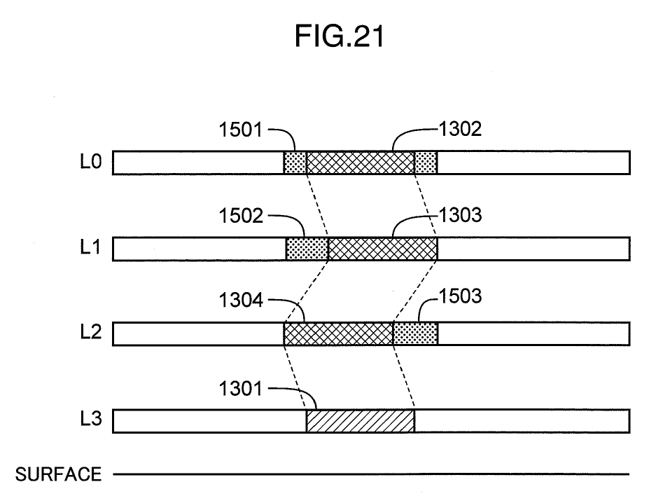

FIG. 21 is a diagram explaining the lamination error of the recording layer according to the second embodiment of the present invention.

In the second embodiment, although the areas in the same radial position as the recording request area are sought, there is a possibility that a lamination error will occur in the respective recording layers during the manufacture of the optical disc. If a lamination error occurs in the areas 1302, 1303, 1304 in the same radial position as the recording request area, as shown in FIG. 21, there is a possibility that they may be disposed by being mutually out of alignment. Thus, whether there is a recorded area in the unrecorded confirmed areas 1501, 1502, 1503, which are obtained by adding the range of lamination error to the areas in the same radial position as the recording request area, may also be sought.

Specifically, number of layers detection unit 135 may detect the number of recording layers including an area in the same radial position as the recording request area, which is within the range of lamination error of recording layers, and with information recorded thereon among the respective recording layers located on the side of the optical entrance surface from a recording layer which is innermost from an optical entrance surface of the information recording medium among recording layers which have an unrecorded area. Consequently, whether there is a recorded area in the areas in the same radial position as the recording request area can be determined with greater accuracy.

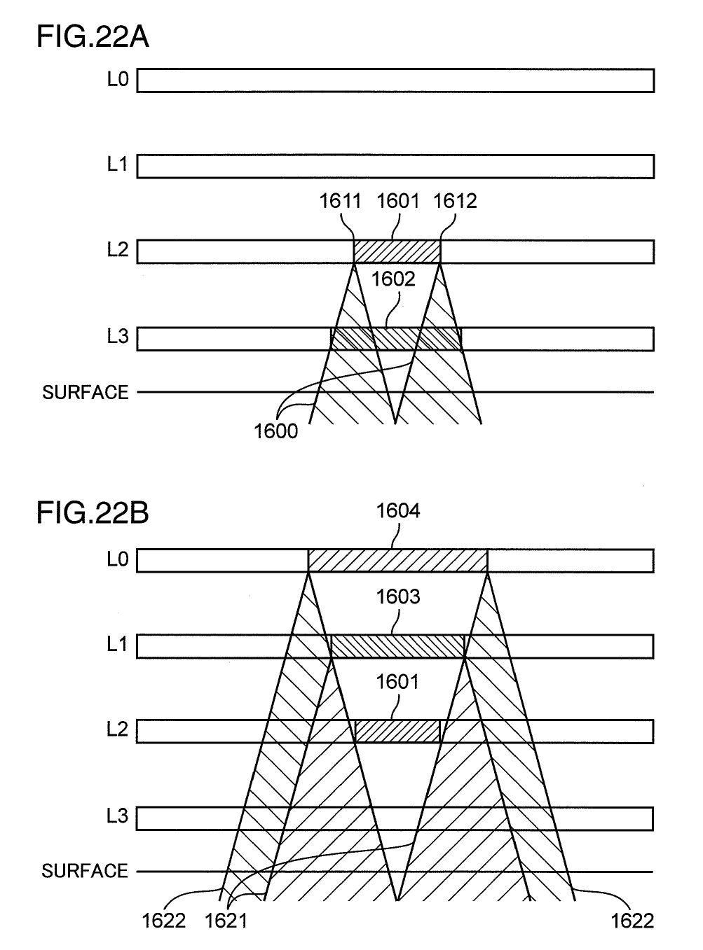

A different determination method of determining whether there is a recorded area in the same radial position as the recording request area according to the second embodiment of the present invention is now explained. FIG. 22A and FIG. 22B are diagrams explaining a different determination method of determining whether there is a recorded area in the same radial position as the recording request area according to the second embodiment of the present invention.

In FIG. 22A, the area 1601 of the third recording layer L2 is the recording request area. As shown in FIG. 22A, when data is recorded in the area 1601, the optical beam 1600 is condensed on the area 1601. Data is recorded in the area 1601 by moving the optical beam 1600 from the recording start position 1611 to the recording end position 1612 of the area 1601. Here, while the optical beam 1600 is moving from the recording start position 1611 to the recording end position 1612, the optical beam 1600 passes through the area 1602 of the fourth recording layer L3. Accordingly, the optical beam 1600 that is condensed on the area 1601 of the third recording layer L2 will be affected by the optical characteristics of the area 1602 of the fourth recording layer L3.

Moreover, as shown in FIG. 22B, the optical beam 1621 that passes through the area 1601 of the third recording layer L2 and condenses on the second recording layer L1 will condense on the area 1603 of the second recording layer L1. In addition, the optical beam 1622 that passes through the area 1601 of the third recording layer L2 and condenses on the first recording layer L0 will condense on the area 1604 of the first recording layer L0. Thus, when recording data in the area 1603 of the second recording layer L1 and the area 1604 of the first recording layer L0, the optical characteristics of the area 1601 will affect the optical beams 1621, 1622.

Accordingly, the information recording/reproduction apparatus of the second embodiment may also determine whether there is a recorded area in the area 1602 of the fourth recording layer L3 in which the recording request area 1601 of the third recording layer L2 will be affected by the optical characteristics, and in the area 1603 of the second recording layer L1 and the area 1604 of the first recording layer L0 in which the recording request area 1601 will have influence based on its optical characteristics.

Specifically, the number of layers detection unit 135 may also detect the number of recording layers including an area in which light that condenses on the recording request area passes therethrough and with information recorded thereon and the number of recording layers including an area onto which light that passed through the recording request area condenses and with information recorded thereon among the respective recording layers located on the side of the optical entrance surface from a recording layer which is innermost from an optical entrance surface of the information recording medium among recording layers which have an unrecorded area. Consequently, whether there is a recorded area in the areas in the same radial position as the recording request area can be determined with greater accuracy.

### Third Embodiment

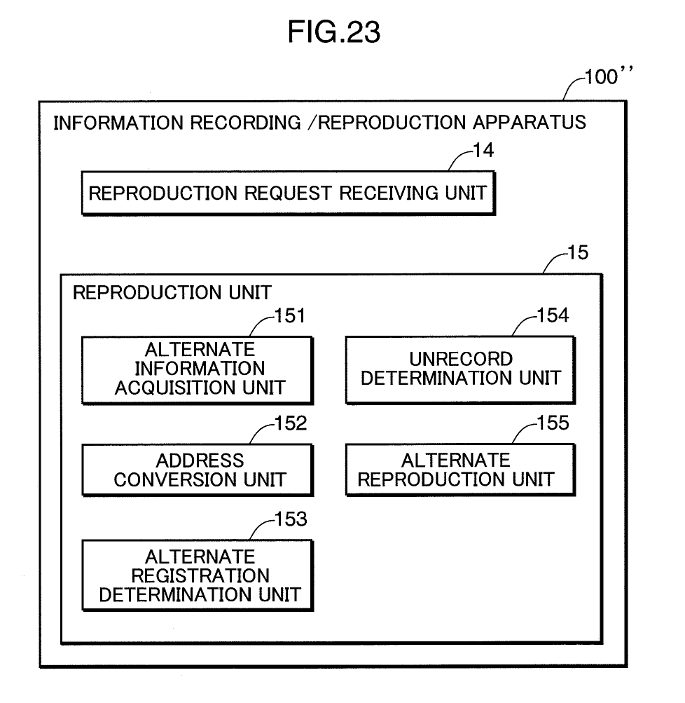

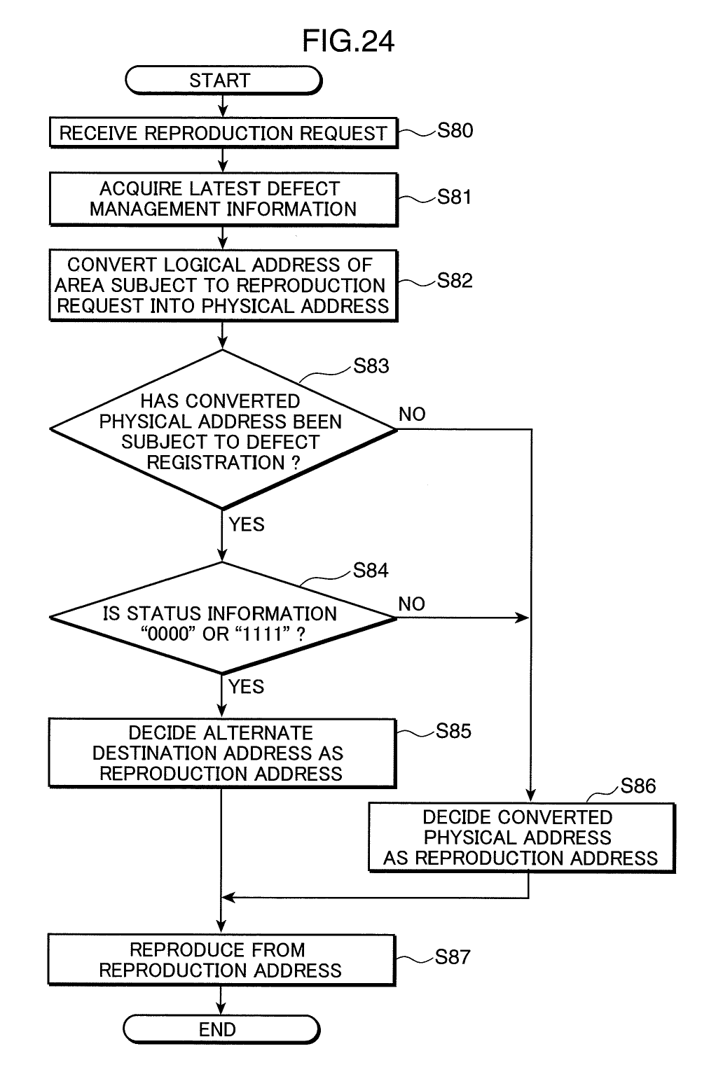

In the third embodiment, the reproduction method of reproducing data recorded on the four-layered BD-R 200 with the recording method illustrated in the first embodiment is explained with reference to FIG. 23 and FIG. 24.

FIG. 23 is a block diagram showing the functional configuration of an information recording/reproduction apparatus 100″ according to the third embodiment of the present invention. The information recording/reproduction apparatus 100″ comprises a reproduction request receiving unit 14 and a reproduction unit 15. Incidentally, in the third embodiment, the information recording/reproduction apparatus 100″ corresponds to an example of the information reproduction apparatus.

The reproduction request receiving unit 14 receives a reproduction request for reproducing information from the optical disc 101. Incidentally, the CPU 106 and the interface control circuit 108 depicted in FIG. 1 function as the reproduction request receiving unit 14.

With the optical disc 101, the number of recording layers including an area with information recorded thereon is limited to a predetermined value N (N≧0) or less with respect to other recording layers in which light passes therethrough until the light reaches an unrecorded area of a recording layer as a recording target.

The reproduction unit 15 comprises an alternate information acquisition unit 151, an address conversion unit 152, an alternate registration determination unit 153, an unrecord determination unit 154 and an alternate reproduction unit 155. Incidentally, the spindle motor 102, the pickup 103, the servo circuit 104, the recording/reproduction circuit 105, the CPU 106, the buffer memory 107 and the interface control circuit 108 depicted in FIG. 1 function as the reproduction unit 15.

The alternate information acquisition unit 151 acquires, from the optical disc 101, alternate information including alternate source information representing a recording request area subject to a recording request, and alternate destination information representing an alternate area of the recording request area. The address conversion unit 152 converts the logical address of an area for reproducing data as designated by the host apparatus 109 into a physical address.

The alternate registration determination unit 153 determines whether the area to be reproduced is registered in the alternate source information. The unrecord determination unit 154 determines whether an area of an alternate source is an unrecorded area if the alternate registration determination unit 153 determines that the area to be reproduced is registered in the alternate source information. The alternate reproduction unit 155 reproduces the alternate area that is registered in the alternate destination information if the unrecord determination unit 154 determines that an area of an alternate source is an unrecorded area.

FIG. 24 is a flowchart showing the reproduction method according to the third embodiment of the present invention.

The host apparatus 109 designates the logical address and the size of the area for reproducing the data, and issues a reproduction command to the information recording/reproduction apparatus 100 via the interface control circuit 108.

Foremost, at step S80, the CPU 106 receives the reproduction command (reproduction request) that was issued by the host apparatus 109. Subsequently, at step S81, the CPU 106 controls the servo circuit 104 to cause the pickup 103 to access the DMA or the TDMA in the inner zone of the respective recording layers. Subsequently, the CPU 106 controls the recording/reproduction circuit 105 to reproduce data from the DMA or the TDMA, and acquires the latest defect management information from the optical disc 101.

Subsequently, at step S82, the CPU 106 converts the logical address of an area for reproducing data as designated by the host apparatus 109 into a physical address.

Subsequently, at step S83, the CPU 106 compares the latest defect management information that was acquired at step S81 and the converted physical address, and determines whether the converted physical address has been subject to defect registration. If it is determined that the converted physical address has been subject to defect registration (step S83; YES), the routine proceeds to the processing of step S84. Meanwhile, if it is determined that the converted physical address has not been subject to defect registration (step S83; NO), the routine proceeds to step S86.

If it is determined that the converted physical address has been subject to defect registration, at step S84, the CPU 106 determines whether the value of the status information (Status 1 of FIG. 6) of the defect list corresponding to the converted physical address is “0000” or “1111.” If it is determined that the value of the status information is “0000” or “1111” (step S84; YES), the routine proceeds to the processing of step S85. Meanwhile, if it is determined that the value of the status information is not “0000” or “1111” (step S84; NO), the routine proceeds to the processing of step S86.

If it is determined that the value of the status information is “0000” or “1111,” at step S85, the CPU 106 decides the address of the alternate destination of the converted physical address as the reproduction address.

If it is determined that the value of the status information is not “0000” or “1111,” or if it is determined at step S83 that the converted physical address has not been subject to defect registration, at step S86, the CPU 106 decides the converted physical address as the reproduction address.

Subsequently, at step S87, the CPU 106 controls the recording/reproduction circuit 105 to reproduce data from the reproduction address that was decided at step S85 or step S86.

As described above, according to the reproduction method of the third embodiment, even if a reproduction request is made to an area that has been alternatively recorded in an area within a recordable range, data can be correctly reproduced by determining the status information of the defect list.

According to the configuration of the third embodiment, with the optical disc 101, the number of recording layers including an area with information recorded thereon is limited to a predetermined value N (N≧0) or less with respect to other recording layers in which light passes therethrough until the light reaches an unrecorded area of a recording layer as a recording target. In addition, a reproduction request for reproducing information from the optical disc 101 can be received. Subsequently, alternate information including alternate source information representing a recording request area subject to a recording request, and alternate destination information representing an alternate area of the recording request area are acquired from the optical disc 101, and whether the area to be reproduced is registered in the alternate source information is determined. If it is determined that the area to be reproduced is registered in the alternate source information, whether an area of an alternate source is an unrecorded area is determined. If it is determined that an area of an alternate source is an unrecorded area, the alternate area registered in the alternate destination information is reproduced.

Accordingly, even if information is alternatively recorded from the recording request area to the alternate area, such information can be accurately reproduced.

In addition, since the physical address to be reproduced is sought based on the defect management information, reproduction in the logical space will not change, and will not affect the processing of the host apparatus.

Incidentally, the specific embodiment described above mainly covers the invention having the following configuration.

The recording method according to one aspect of the present invention comprises a recording request receiving step of receiving a recording request for recording information on an information recording medium including two or more recording layers, and a recording step of recording the information by, limiting the number of recording layers including an area with information recorded thereon to a predetermined value N (N≧0) or less with respect to other recording layers in which light passes therethrough until the light reaches an unrecorded area of a recording layer as a recording target.

According to the foregoing configuration, it is possible to receive a recording request for recording information on an information recording medium including two or more recording layers. In addition, information is recorded by, limiting the number of recording layers including an area with information recorded thereon to a predetermined value N (N≧0) or less with respect to other recording layers in which light passes therethrough until the light reaches an unrecorded area of a recording layer as a recording target.

Accordingly, because the number of recording layers including an area with information recorded thereon is limited to a predetermined value N (N≧0) or less with respect to other recording layers in which light passes therethrough until the light reaches an unrecorded area of a recording layer as a recording target, it is possible to reduce the influence that the light which reaches an unrecorded area of a recording layer as a recording target will receive from the optical characteristics of other recording layers, and guarantee the recording quality of the multilayered information recording medium.

Moreover, in the foregoing recording method, the recording step preferably includes a determination step of determining whether a recording request area on a recording layer that is specified based on the recording request exists between a recording layer which is innermost from an optical entrance surface of the information recording medium among recording layers which have an unrecorded area and a recording layer closer to the side of the optical entrance surface for the predetermined value N from the recording layer which is innermost from the optical entrance surface of the information recording medium among recording layers which have an unrecorded area, and an alternate recording step of deciding, if it is determined that the recording request area does not exist between a recording layer which is innermost from an optical entrance surface of the information recording medium among recording layers which have an unrecorded area and a recording layer closer to the side of the optical entrance surface for the predetermined value N from the recording layer which is innermost from the optical entrance surface of the information recording medium among recording layers which have an unrecorded area in the determination step, an unrecorded area existing between a recording layer which is innermost from an optical entrance surface of the information recording medium among recording layers which have an unrecorded area and a recording layer closer to the side of the optical entrance surface for the predetermined value N from the recording layer which is innermost from the optical entrance surface of the information recording medium among recording layers which have an unrecorded area as an alternate area, and recording information to be recorded on the recording request area in the alternate area.

According to the foregoing configuration, whether a recording request area on a recording layer that is specified based on the recording request exists between a recording layer which is innermost from an optical entrance surface of the information recording medium among recording layers which have an unrecorded area and a recording layer closer to the side of the optical entrance surface for the predetermined value N from the recording layer which is innermost from the optical entrance surface of the information recording medium among recording layers which have an unrecorded area is determined. In addition, if it is determined that the recording request area does not exist between a recording layer which is innermost from an optical entrance surface of the information recording medium among recording layers which have an unrecorded area and a recording layer closer to the side of the optical entrance surface for the predetermined value N from the recording layer which is innermost from the optical entrance surface of the information recording medium among recording layers which have an unrecorded area, an unrecorded area existing between a recording layer which is innermost from an optical entrance surface of the information recording medium among recording layers which have an unrecorded area and a recording layer closer to the side of the optical entrance surface for the predetermined value N from the recording layer which is innermost from the optical entrance surface of the information recording medium among recording layers which have an unrecorded area is decided as an alternate area, and information to be recorded on the recording request area is recorded on the alternate area.

Accordingly, since information to be recorded on the recording request area will be recorded on an unrecorded area existing between a recording layer which is innermost from an optical entrance surface of the information recording medium among recording layers which have an unrecorded area and a recording layer closer to the side of the optical entrance surface for the predetermined value N from the recording layer which is innermost from the optical entrance surface of the information recording medium among recording layers which have an unrecorded area if it is determined that the recording request area does not exist between a recording layer which is innermost from an optical entrance surface of the information recording medium among recording layers which have an unrecorded area and a recording layer closer to the side of the optical entrance surface for the predetermined value N from the recording layer which is innermost from the optical entrance surface of the information recording medium among recording layers which have an unrecorded area, it is possible to guarantee the recording quality of the multilayered information recording medium.

Moreover, in the foregoing recording method, the recording step preferably includes a detection step of detecting the number of recording layers including an area in the same radial position as the recording request area that was subject to the recording request and with information recorded thereon among the respective recording layers located on the side of the optical entrance surface from a recording layer which is innermost from an optical entrance surface of the information recording medium among recording layers which have an unrecorded area, a determination step of determining whether the number of recording layers detected in the detection step is the predetermined value N or higher, and an alternate recording step of deciding, if it is determined that the detected number of recording layers is the predetermined value N or higher, an unrecorded area existing between a recording layer which is innermost from an optical entrance surface of the information recording medium among recording layers which have an unrecorded area and a recording layer closer to the side of the optical entrance surface for the predetermined value N from the recording layer which is innermost from the optical entrance surface of the information recording medium among recording layers which have an unrecorded area as an alternate area, and recording information to be recorded in the recording request area in the alternate area.

According to the foregoing configuration, the number of recording layers including an area in the same radial position as the recording request area that was subject to the recording request and with information recorded thereon among the respective recording layers located on the side of the optical entrance surface from a recording layer which is innermost from an optical entrance surface of the information recording medium among recording layers which have an unrecorded area is detected. In addition, whether the number of recording layers detected in the detection step is the predetermined value N or higher is determined. If it is determined that the detected number of recording layers is the predetermined value N or higher, an unrecorded area existing between a recording layer which is innermost from an optical entrance surface of the information recording medium among recording layers which have an unrecorded area and a recording layer closer to the side of the optical entrance surface for the predetermined value N from the recording layer which is innermost from the optical entrance surface of the information recording medium among recording layers which have an unrecorded area is decided as an alternate area, and information to be recorded on the recording request area is recorded on the alternate area.

Accordingly, since information to be recorded on the recording request area will be recorded on an unrecorded area existing between a recording layer which is innermost from an optical entrance surface of the information recording medium among recording layers which have an unrecorded area and a recording layer closer to the side of the optical entrance surface for the predetermined value N from the recording layer which is innermost from the optical entrance surface of the information recording medium among recording layers which have an unrecorded area if it is determined that the detected number of recording layers is the predetermined value N or higher, it is possible to guarantee the recording quality of the multilayered information recording medium.

Moreover, according to the foregoing recording method, the detection step preferably detects the number of recording layers including an area in the same radial position as the recording request area, which is within the range of lamination error of recording layers, and with information recorded thereon among the respective recording layers located on the side of the optical entrance surface from a recording layer which is innermost from an optical entrance surface of the information recording medium among recording layers which have an unrecorded area.

According to the foregoing configuration, the number of recording layers including an area in the same radial position as the recording request area, which is within the range of lamination error of recording layers, and with information recorded thereon among the respective recording layers located on the side of the optical entrance surface from a recording layer which is innermost from an optical entrance surface of the information recording medium among recording layers which have an unrecorded area is detected.

Accordingly, since consideration is given to the lamination error of recording layers, the number of recording layers including an area in the same radial position as the recording request area and with information recorded thereon can be detected even more accurately.

Moreover, in the foregoing recording method, the detection step preferably detects the number of recording layers including an area in which light that condenses on the recording request area passes therethrough and with information recorded thereon and the number of recording layers including an area onto which light that passed through the recording request area condenses and with information recorded thereon among the respective recording layers located on the side of the optical entrance surface from a recording layer which is innermost from an optical entrance surface of the information recording medium among recording layers which have an unrecorded area.

According to the foregoing configuration, the number of recording layers including an area in which light that condenses on the recording request area passes therethrough and with information recorded thereon and the number of recording layers including an area onto which light that passed through the recording request area condenses and with information recorded thereon among the respective recording layers located on the side of the optical entrance surface from a recording layer which is innermost from an optical entrance surface of the information recording medium among recording layers which have an unrecorded area are detected.

Accordingly, since consideration is given to the optical characteristics of the area in which light that condenses on the recording request area passes therethrough and the area onto which light that passed through the recording request area condenses, the number of recording layers including an area in the same radial position as the recording request area and with information recorded thereon can be detected even more accurately.

Moreover, preferably, the foregoing recording method further includes a predetermined value deciding step of deciding the predetermined value N based on control data that is recorded during the manufacture of the information recording medium. According to the foregoing configuration, the predetermined value N can be decided based on control data that is recorded during the manufacture of the information recording medium.

Moreover, in the foregoing recording method, the control data preferably includes a recordable limiting value representing the number of recording layers in which the recording quality of recording layers including an area with information recorded thereon is guaranteed, and wherein the predetermined value deciding step preferably decides the predetermined value N based on the recordable limiting value. According to the foregoing configuration, the predetermined value N can be decided based on the recordable limiting value representing the number of recording layers in which the recording quality of recording layers including an area with information recorded thereon is guaranteed.

Moreover, preferably, the foregoing recording method further includes a predetermined value deciding step of deciding the predetermined value N based on the number of recording layers of the information recording medium. According to the foregoing configuration, the predetermined value N can be decided based on the number of recording layers of the information recording medium.

Moreover, preferably, the foregoing recording method further includes a predetermined value deciding step of deciding the predetermined value N based on the version information representing the type of the information recording medium. According to the foregoing configuration, the predetermined value N can be decided based on the version information representing the type of the information recording medium.

Moreover, in the foregoing recording method, the alternate area is preferably an unrecorded area in a recording layer which is innermost from an optical entrance surface of the information recording medium among recording layers which have an unrecorded area.

According to the foregoing configuration, since information to be recorded on the recording request area will recorded in order from the a recording layer which is innermost from an optical entrance surface of the information recording medium among recording layers which have an unrecorded area if it is determined that the recording request subject to the recording request area does not exist between a recording layer which is innermost from an optical entrance surface of the information recording medium among recording layers which have an unrecorded area and a recording layer closer to the side of the optical entrance surface for the predetermined value N from the recording layer which is innermost from the optical entrance surface of the information recording medium among recording layers which have an unrecorded area, information can be recorded efficiently.

Moreover, in the foregoing recording method, the alternate area is preferably an unrecorded area that is closest to the same radial position as the recording request area.

According to the foregoing configuration, since information to be recorded on the recording request area will be recorded on an unrecorded area that is closest to the same radial position as the recording request area if it is determined that the recording request subject to the recording request area does not exist between a recording layer which is innermost from an optical entrance surface of the information recording medium among recording layers which have an unrecorded area and a recording layer closer to the side of the optical entrance surface for the predetermined value N from the recording layer which is innermost from the optical entrance surface of the information recording medium among recording layers which have an unrecorded area, the time required for moving the pickup from the recording request area to the alternate area can be reduced.

The information recording apparatus according to another aspect of the present invention comprises a recording request receiving unit for receiving a recording request for recording information on an information recording medium including two or more recording layers, and a recording unit for recording the information by, limiting the number of recording layers including an area with information recorded thereon to a predetermined value N (N≧0) or less with respect to other recording layers in which light passes therethrough until the light reaches an unrecorded area of a recording layer as a recording target.

According to the foregoing configuration, it is possible to receive a recording request for recording information on an information recording medium including two or more recording layers. In addition, information is recorded by, limiting the number of recording layers including an area with information recorded thereon to a predetermined value N (N≧0) or less with respect to other recording layers in which light passes therethrough until the light reaches an unrecorded area of a recording layer as a recording target.

Accordingly, because the number of recording layers including an area with information recorded thereon is limited to a predetermined value N (N≧0) or less with respect to other recording layers in which light passes therethrough until the light reaches an unrecorded area of a recording layer as a recording target, it is possible to reduce the influence that the light which reaches an unrecorded area of a recording layer as a recording target will receive from the optical characteristics of other recording layers, and guarantee the recording quality of the multilayered information recording medium.

The information recording medium according to yet another aspect of the present invention comprises two or more recording layers, wherein the number of recording layers including an area with information recorded thereon is limited to a predetermined value N (N≧0) or less with respect to other recording layers in which light passes therethrough until the light reaches an unrecorded area of a recording layer as a recording target.

According to the foregoing configuration, the number of recording layers including an area with information recorded thereon is limited to a predetermined value N (N≧0) or less with respect to other recording layers in which light passes therethrough until the light reaches an unrecorded area of a recording layer as a recording target.

Accordingly, because the number of recording layers including an area with information recorded thereon is limited to a predetermined value N (N≧0) or less with respect to other recording layers in which light passes therethrough until the light reaches an unrecorded area of a recording layer as a recording target, it is possible to reduce the influence that the light which reaches an unrecorded area of a recording layer as a recording target will receive from the optical characteristics of other recording layers, and guarantee the recording quality of the multilayered information recording medium.

Moreover, in the foregoing information recording medium, the recording layer has preferably recorded thereon alternate information including alternate source information representing a recording request area subject to a recording request, and alternate destination information representing an alternate area of the recording request area, and wherein the alternate source information preferably has an unrecorded area registered therein.

According to the foregoing configuration, the recording layer has recorded thereon alternate information including alternate source information representing a recording request area subject to a recording request, and alternate destination information representing an alternate area of the recording request area, and the alternate source information has an unrecorded area registered therein. Accordingly, since an unrecorded area, and not a defect area, is recorded as the alternate source area, information can be additional recorded on such unrecorded area.

The reproduction method according to yet another aspect of the present invention is a reproduction method of reproducing information from an information recording medium including two or more recording layers, wherein, with the information recording medium, the number of recording layers including an area with information recorded thereon is limited to a predetermined value N (N≧0) or less with respect to other recording layers in which light passes therethrough until the light reaches an unrecorded area of a recording layer as a recording target. This reproduction method comprises a reproduction request receiving step of receiving a reproduction request for reproducing information from the information recording medium, an alternate information acquisition step of acquiring, from the information recording medium, alternate information including alternate source information representing a recording request area subject to a recording request, and alternate destination information representing an alternate area of the recording request area, an alternate registration determination step of determining whether the area to be reproduced is registered in the alternate source information, an unrecord determination step of determining whether an area of an alternate source is an unrecorded area if it is determined that the area to be reproduced is registered in the alternate source information at the alternate registration determination step, and a reproduction step of reproducing the alternate area registered in the alternate destination information if it is determined that an area of an alternate source is an unrecorded area at the unrecord determination step.

According to the foregoing configuration, the number of recording layers including an area with information recorded thereon is limited to a predetermined value N (N≧0) or less with respect to other recording layers in which light passes therethrough until the light reaches an unrecorded area of a recording layer as a recording target. In addition, a reproduction request for reproducing information from the information recording medium can be received. Subsequently, alternate information including alternate source information representing a recording request area subject to a recording request, and alternate destination information representing an alternate area of the recording request area are acquired from the information recording medium, and whether the area to be reproduced is registered in the alternate source information is determined. If it is determined that the area to be reproduced is registered in the alternate source information, whether an area of an alternate source is an unrecorded area is determined. If it is determined that an area of an alternate source is an unrecorded area, the alternate area registered in the alternate destination information is reproduced.

Accordingly, even if information is alternatively recorded from the recording request area to the alternate area, such information can be accurately reproduced.

The information reproduction apparatus according to yet another aspect of the present invention is an information reproduction apparatus for reproducing information from an information recording medium including two or more recording layers, wherein, for the information recording medium, the number of recording layers including an area with information recorded thereon is limited to a predetermined value N (N≧0) or less with respect to other recording layers in which light passes therethrough until the light reaches an unrecorded area of a recording layer as a recording target. This information reproduction apparatus comprises a reproduction request receiving unit for receiving a reproduction request for reproducing information from the information recording medium, an alternate information acquisition unit for acquiring, from the information recording medium, alternate information including alternate source information representing a recording request area subject to a recording request, and alternate destination information representing an alternate area of the recording request area, an alternate registration determination unit for determining whether the area to be reproduced is registered in the alternate source information, an unrecord determination unit of determining whether an area of an alternate source is an unrecorded area if it is determined that the area to be reproduced is registered in the alternate source information with the alternate registration determination unit, and a reproduction unit for reproducing the alternate area registered in the alternate destination information if it is determined that an area of an alternate source is an unrecorded area with the unrecord determination unit.

According to the foregoing configuration, the number of recording layers including an area with information recorded thereon is limited to a predetermined value N (N≧0) or less with respect to other recording layers in which light passes therethrough until the light reaches an unrecorded area of a recording layer as a recording target. In addition, a reproduction request for reproducing information from the information recording medium can be received. Subsequently, alternate information including alternate source information representing a recording request area subject to a recording request, and alternate destination information representing an alternate area of the recording request area are acquired from the information recording medium, and whether the area to be reproduced is registered in the alternate source information is determined. If it is determined that the area to be reproduced is registered in the alternate source information, whether an area of an alternate source is an unrecorded area is determined. If it is determined that an area of an alternate source is an unrecorded area, the alternate area registered in the alternate destination information is reproduced.

Accordingly, even if information is alternatively recorded from the recording request area to the alternate area, such information can be accurately reproduced.

The recording method, information recording apparatus, information recording medium, reproduction method and information reproduction apparatus according to the present invention are able to guarantee the recording quality of the multilayered information recording medium, and can be applied to the usage of optical disc drive devices and the like.

This application is based on Japanese Patent Application No. 2008-240504 filed on Sep. 19, 2008, the contents of which are hereby incorporated by reference.

Incidentally, the specific embodiments and examples provided in the foregoing detailed description of the preferred embodiments are merely explained to clarify the technical content of the present invention. Thus, the present invention should not be narrowly interpreted by being limited to such specific embodiments and examples, and may be variously modified and implemented within the spirit of this invention and the scope of claims provided below.

What is claimed is:

1. A recording method, comprising:
a recording request receiving step of receiving a recording request for recording information on an information recording medium including two or more recording layers; and
a recording step of recording the information by, limiting the number of recording layers including an area with information recorded thereon to a predetermined value N (N≧0) or less with respect to other recording layers in which the light passes therethrough until light reaches an unrecorded area of a recording layer as a recording target.

2. The recording method according to claim 1,
wherein the recording step includes:
a determination step of determining whether a recording request area on a recording layer that is specified based on the recording request exists between a recording layer which is innermost from an optical entrance surface of the information recording medium among recording layers which have an unrecorded area and a recording layer closer to the side of the optical entrance surface for the predetermined value N from the recording layer which is innermost from the optical entrance surface of the information recording medium among recording layers which have an unrecorded area; and
an alternate recording step of deciding, when determination is made that the recording request area does not exist between a recording layer which is innermost from an optical entrance surface of the information recording medium among recording layers which have an unrecorded area and a recording layer closer to the side of the optical entrance surface for the predetermined value N from the recording layer which is innermost from the optical entrance surface of the information recording medium among recording layers which have an unrecorded area in the determination step, an unrecorded area existing between a recording layer which is innermost from an optical entrance surface of the information recording medium among recording layers which have an unrecorded area and a recording layer closer to the side of the optical entrance surface for the predetermined value N from the recording layer which is innermost from the optical entrance surface of the information recording medium among recording layers which have an unrecorded area as an alternate area, and recording in the alternate area information to be recorded on the recording request area.

3. The recording method according to claim 1,
wherein the recording step includes:
a detection step of detecting the number of recording layers including an area in the same radial position as the recording request area that has been subjected to the recording request and has information recorded thereon among the respective recording layers located on the side of the optical entrance surface from a recording layer which is innermost from an optical entrance surface of the information recording medium among recording layers which have an unrecorded area;
a determination step of determining whether the number of recording layers detected in the detection step is the predetermined value N or higher; and
an alternate recording step of deciding, when determination is made that the detected number of recording layers is the predetermined value N or higher, an unrecorded area existing between a recording layer which is innermost from an optical entrance surface of the information recording medium among recording layers which have an unrecorded area and a recording layer closer to the side of the optical entrance surface for the predetermined value N from the recording layer which is innermost from the optical entrance surface of the information recording medium among recording layers which have an unrecorded area as an alternate area, and recording in the alternate area information to be recorded on the recording request area.

4. The recording method according to claim 3,
wherein the detection step detects the number of recording layers including an area which is in the same radial position as the recording request area, and is within the range of lamination error of recording layers, and has information recorded thereon among the respective recording layers located on the side of the optical entrance surface from a recording layer which is innermost from an optical entrance surface of the information recording medium among recording layers which have an unrecorded area.

5. The recording method according to claim 3,
wherein the detection step detects the number of recording layers including an area in which light that condenses on the recording request area passes therethrough and has information recorded thereon and the number of recording layers including an area onto which light that has passed through the recording request area condenses and has information recorded thereon among the respective recording layers located on the side of the optical entrance surface from a recording layer which is innermost from an optical entrance surface of the information recording medium among recording layers which have an unrecorded area.

6. The recording method according to claim 1, further comprising a predetermined value deciding step of deciding the predetermined value N based on control data that is recorded during the manufacture of the information recording medium.

7. The recording method according to claim 6, wherein
the control data includes a recordable limiting value representing the number of recording layers in which the recording quality of recording layers including an area with information recorded thereon is guaranteed, and
the predetermined value deciding step decides the predetermined value N based on the recordable limiting value.

8. The recording method according to claim 1, further comprising a predetermined value deciding step of deciding the predetermined value N based on the number of recording layers of the information recording medium.

9. The recording method according to claim 1, further comprising a predetermined value deciding step of deciding the predetermined value N based on version information representing the type of the information recording medium.

10. The recording method according to claim 2, wherein the alternate area is an unrecorded area in a recording layer which is innermost from an optical entrance surface of the information recording medium among recording layers which have an unrecorded area.

11. The recording method according to claim 2, wherein the alternate area is an unrecorded area that is closest to the same radial position as the recording request area.

12. An information recording apparatus, comprising:
a recording request receiving unit for receiving a recording request for recording information on an information recording medium including two or more recording layers; and
a recording unit for recording the information by, limiting the number of recording layers including an area with information recorded thereon to a predetermined value N (N≧0) or less with respect to other recording layers in which the light passes therethrough until the light reaches an unrecorded area of a recording layer as a recording target.

13. An information recording medium, comprising two or more recording layers, wherein
the number of recording layers including an area with information recorded thereon is limited to a predetermined value N (N≧0) or less with respect to other recording layers in which the light passes therethrough until light reaches an unrecorded area of a recording layer as a recording target.

14. The information recording medium according to claim 13, wherein
the recording layer has recorded thereon alternate information including alternate source information representing a recording request area subjected to a recording request, and alternate destination information representing an alternate area of the recording request area, and
the alternate source information has an unrecorded area registered therein.

15. A reproduction method of reproducing information from an information recording medium including two or more recording layers,
wherein for the information recording medium, the number of recording layers including an area with information recorded thereon is limited to a predetermined value N (N≧0) or less with respect to other recording layers in which the light passes therethrough until light reaches an unrecorded area of a recording layer as a recording target,
the reproduction method comprising:
a reproduction request receiving step of receiving a reproduction request for reproducing information from the information recording medium;
an alternate information acquisition step of acquiring, from the information recording medium, alternate information including alternate source information representing a recording request area subjected to a recording request, and alternate destination information representing an alternate area of the recording request area;
an alternate registration determination step of determining whether the area to be reproduced is registered in the alternate source information;
an unrecord determination step of determining whether an area of an alternate source is an unrecorded area when determination is made that the area to be reproduced is registered in the alternate source information in the alternate registration determination step; and
a reproduction step of reproducing the alternate area registered in the alternate destination information when determination is made that an area of an alternate source is an unrecorded area in the unrecord determination step.

16. An information reproduction apparatus for reproducing information from an information recording medium including two or more recording layers, wherein
for the information recording medium, the number of recording layers including an area with information recorded thereon is limited to a predetermined value N (N≧0) or less with respect to other recording layers in which the light passes therethrough until light reaches an unrecorded area of a recording layer as a recording target,
the information reproduction apparatus comprising:
a reproduction request receiving unit for receiving a reproduction request for reproducing information from the information recording medium;
an alternate information acquisition unit for acquiring, from the information recording medium, alternate information including alternate source information representing a recording request area subjected to a recording request, and alternate destination information representing an alternate area of the recording request area;
an alternate registration determination unit for determining whether the area to be reproduced is registered in the alternate source information;
an unrecord determination unit of determining whether an area of an alternate source is an unrecorded area when determination is made that the area to be reproduced is registered in the alternate source information by the alternate registration determination unit; and
a reproduction unit for reproducing the alternate area registered in the alternate destination information when determination is made that an area of an alternate source is an unrecorded area by the unrecord determination unit.
